(19) United States
(12) Patent Application Publication
(10) Pub. No.: US 2025/0081272 A1
(43) Pub. Date: Mar. 6, 2025

(54) METHOD AND DEVICE FOR WIRELESS COMMUNICATION

(71) Applicants: Yu CHEN, Shanghai (CN); Xiaobo ZHANG, Shanghai (CN)

(72) Inventors: Yu CHEN, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/815,881

(22) Filed: Aug. 27, 2024

(30) Foreign Application Priority Data
Sep. 1, 2023 (CN) 202311125346.X

(51) Int. Cl. H04W 76/20; H04W 8/22; H04W 24/02

(52) U.S. Cl. CPC H04W 76/20; H04W 8/22; H04W 24/02

(57) ABSTRACT

The present application comprising receiving a first signaling, the first signaling comprising a first RRC information element, the first signaling configuring a first condition set and a first time window; there existing a dependency relation between the first condition set and the first time window; an execution of the first RRC information element depending on the first condition set; herein, the first RRC information element configures a target cell of the first node; the meaning of the phrase that an execution of the first RRC information element depends on the first condition set is: when at least one condition in the first condition set is not met, the first RRC information element is not executed; when all conditions in the first condition set are met, the first RRC information element is delayed in execution; the delayed in execution is not later than an end of the first time window.

### CROSS REFERENCE TO RELATED APPLICATIONS

This application claims the priority benefit of Chinese Patent Application No. 202311125346.X, filed on Sep. 1, 2023, the full disclosure of which is incorporated herein by reference.

### BACKGROUND

### Technical Field

The present application relates to transmission methods and devices in wireless communication systems, involving mobility management, handover, radio link failure, and artificial intelligence.

### Related Art

Application scenarios of future wireless communication systems are becoming increasingly diversified, and different application scenarios have different performance demands on systems. In order to meet different performance requirements of various application scenarios, 3rd Generation Partner Project (3GPP) Radio Access Network (RAN) #72th plenary decided to conduct a study of New Radio (NR), or what is called fifth Generation (5G). A work Item (WI) of NR was approved at 3GPP RAN #75th plenary to start standardization work on NR.

In communications, whether Long Term Evolution (LTE) or 5G NR involves features of accurate reception of reliable information, optimized energy efficiency ratio, determination of information efficiency, flexible resource allocation, scalable system structure, efficient non-access layer information processing, low service interruption and dropping rate and support for low power consumption, which are of great significance to the maintenance of normal communications between a base station and a UE, reasonable scheduling of resources and balancing of system payload. Those features can be called the cornerstone of high throughout and are characterized in meeting communication requirements of various service, improving spectrum utilization and improving service quality, which are indispensable in enhanced Mobile BroadBand (eMBB), Ultra Reliable Low Latency Communications (URLLC) and enhanced Machine Type Communications (eMTC). Meanwhile, in the following communication modes, covering Industrial Internet of Things (IIoT), Vehicular to X (V2X), Device to Device communications, Unlicensed Spectrum communications, User communication quality monitoring, network planning optimization, Territorial Networks (TN), and Dual connectivity system, there are extensive requirements in radio resource management and selection of multi-antenna codebooks as well as in signaling design, adjacent cell management, service management and beamforming. Transmission methods of information are divided into broadcast transmission and unicast transmission, both of which are essential for 5G system for that they are very helpful to meet the above requirements.

With the increase of scenarios and complexity of systems, higher requirements are raised for interruption rate and time delay reduction, reliability and system stability enhancement, service flexibility and power saving. At the same time, compatibility between different versions of different systems should be considered when designing the systems.

Concepts, terms, and abbreviations used in the present application can refer to the 3GPP standard, including but not limited to:
https://www.3gpp.org/ftp/Specs/archive/21_series/21.905/21905-h10.zip
https://www.3gpp.org/ftp/Specs/archive/38_series/38.300/38300-h10.zip
https://www.3gpp.org/ftp/Specs/archive/38_series/38.331/38331-h10.zip
https://www.3gpp.org/ftp/Specs/archive/38_series/38.321/38321-h10.zip
https://www.3gpp.org/ftp/Specs/archive/38_series/38.133/38133-h10.zip

### SUMMARY

Researchers have found that it is a problem to be solved how to control when and under what conditions an RRC information element, i.e., the first RRC information element, is executed in wireless communications. Researchers further found that an RRC information element can be executed only when certain conditions are met, which helps to reduce signaling overhead and control delay, this is due to the fact that the terminal reacts all situations to the network and then waits for the network to make a decision, which inevitably introduces a delay, equivalent to delayed decision making, and the delay in decision making may lead to interruption or failure in communications; such a problem can be avoided by having the terminal execute an RRC information element according to whether conditions associated with an RRC information element configured by the network are met, and then executing the RRC information element once it is met; however, this requires the network to pre-configure this execution condition very accurately, which puts high demands on the network, especially in scenarios with complex channel environment, where the network may not be able to configure a very appropriate execution condition in advance, which makes the pre-configured condition-based execution of the RRC information element still unable to achieve the desired results. Researchers found that the terminal has a more accurate understanding of wireless environment than the network, for example, in order to save signaling overhead, measurement results are quantized and compressed, which invariably brings some errors, on the other hand, the terminal holds some information about itself, such as information related to processing power, communication habits, and etc., which may not be available to the network, even for privacy reasons; furthermore, with the continuous enhancement of terminal's capabilities, especially the introduction of artificial intelligence technology, it is possible for the terminal to have more accurate judgments about when and under what conditions RRC information elements should be executed. Therefore, the researchers found that using the capabilities of the terminal, rather than relying solely on the execution conditions configured by the network, can solve the above problems, and facilitate a more appropriate and accurate determination of when to execute an RRC information element, at least in terms of mobility management, switching, and determination of wireless link failure.

To address the above problem, the present application provides a solution.

It should be noted that if no conflict is incurred, embodiments in any node in the present application and the characteristics of the embodiments are also applicable to any other node, and vice versa. And the embodiments in the present application and the characteristics in the embodiments can be arbitrarily combined if there is no conflict. Meanwhile, the method proposed in the present application can also be used to solve other communication problems, such as NR evolution and problems in 6G systems, and the present application is applicable to various 3GPP-based communication networks.

In one embodiment, interpretations of the terminology in the present application refer to definitions given in the 3GPP TS38 series.

In one embodiment, interpretations of the terminology in the present application refer to definitions given in the 3GPP TS37 series.

The present application provides a method in a first node for wireless communications, comprising:
receiving a first signaling, the first signaling comprising a first RRC information element, the first signaling configuring a first condition set and a first time window; there existing a dependency relation between the first condition set and the first time window; an execution of the first RRC information element depending on the first condition set;
herein, the first RRC information element configures a target cell of the first node; the meaning of the phrase that an execution of the first RRC information element depends on the first condition set is: when at least one condition in the first condition set is not met, the first RRC information element is not executed; when all conditions in the first condition set are met, the first RRC information element is delayed in execution; the delayed in execution is not later than an end of the first time window.

In one embodiment, a problem to be solved in the present application comprises: how to control the execution of the first RRC information element, and/or how to delay the execution of the first RRC information element.

In one embodiment, advantages of the above method comprise: being advantageous to reduce signaling overhead, to reduce signaling delay, to avoid communication interruption, to avoid dropping, to improve the success rate of handover, to help avoid radio link failure, to help protect user privacy, and to help increase flexibility.

Specifically, according to one aspect of the present application, the meaning of the phrase that there exists a dependency relation between the first condition set and the first time window is: the first condition set depending on the first time window.

Specifically, according to one aspect of the present application, the meaning of the phrase that there exists a dependency relation between the first condition set and the first time window is: the first time window depends on the first condition set.

Specifically, according to one aspect of the present application, the first signaling comprises first indication information, the first indication information indicates that when all conditions in the first condition set are met, the first RRC information element is allowed to be delayed in execution.

Specifically, according to one aspect of the present application, the meaning of the delayed execution comprises: when all conditions in the first condition set are met, and only when the second condition set is met, the first RRC information element is executed; the second condition set is not explicitly indicated.

Specifically, according to one aspect of the present application, the second condition set comprises at least one prediction-based condition.

Specifically, according to one aspect of the present application, the prediction comprises a prediction of at least one channel quality, handover failure probability, handover success probability, interruption probability, throughput rate, or quality of user experience.

Specifically, according to one aspect of the present application, the second condition set comprises at least one of being at a location determined by the first location information and being within a time determined by first time information.

Specifically, according to one aspect of the present application, transmit first information; the first information indicates a second capability;

herein, the second capability supports a first-type generator; the first-type generator depends on training; the first-type generator determines whether the second condition set is met.

Specifically, according to one aspect of the present application, transmit first information; the first information indicates a first capability;

herein, the first capability supports a delayed execution for the first RRC information element; the first signaling depends on the first capability.

Specifically, according to one aspect of the present application, receive a second signaling, the second signaling comprises a first parameter set, and a generation of the first location information and the first time information depends on the first parameter set;

herein, the meaning of the phrase that a generation of the first location information and the first time information depends on the first parameter set comprises: the first parameter set indicates a prediction model that generates at least one of the first location information or the first time information, or the training of the prediction model that generates at least one of the first location information or the first time information depends on the first parameter set.

Specifically, according to one aspect of the present application, the first signaling comprises multiple RRC information elements, the first RRC information element is one of the multiple RRC information elements, and each of the multiple RRC information elements is associated with a condition set, and when a condition set associated with any of the multiple RRC information elements is not met, the any RRC information element in the multiple RRC information elements is not executed; when a condition set associated with any of the multiple RRC information elements is met, an execution of the any RRC information element in the multiple RRC information elements is delayed.

Specifically, according to one aspect of the present application, the first node is an IoT terminal.

Specifically, according to one aspect of the present application, the first node is a UE.

Specifically, according to one aspect of the present application, the first node is an access network device.

Specifically, according to one aspect of the present application, the first node is a vehicle terminal.

Specifically, according to one aspect of the present application, the first node is a mobile phone.

Specifically, according to one aspect of the present application, the first node supports multiple SIM cards.

The present application provides a first node for wireless communications, comprising:
a first receiver, receiving a first signaling, the first signaling comprising a first RRC information element, the first signaling configuring a first condition set and a first time window; there existing a dependency relation between the first condition set and the first time window; an execution of the first RRC information element depending on the first condition set;
herein, the first RRC information element configures a target cell of the first node; the meaning of the phrase that an execution of the first RRC information element depends on the first condition set is: when at least one condition in the first condition set is not met, the first RRC information element is not executed; when all conditions in the first condition set are met, the first RRC information element is delayed in execution; the delayed in execution is not later than an end of the first time window.

In one embodiment, the present application has the following advantages over conventional schemes:
a condition set configured by the network for determining whether to execute the first RRC information element, i.e., a first condition set, may be configured more loosely, so that when the first condition set is met, the terminal utilizes its own capability to accurately judge the optimal timing for executing the first RRC information element, which eases the implementation difficulty of the network, i.e., there is no need to predict in advance the best condition for determining whether to execute the first RRC information element; on the other hand, the method proposed in the present application is also conducive to saving signaling overhead, otherwise, in order to obtain the optimal timing for timely and accurate execution of the first RRC information element, the terminal needs to frequently report a large amount of information, such as the measurement results, for the network to make a decision or needs to continuously receive the network's updated or corrected conditions for executing the first RRC information element, whereas by using the method proposed in the present application, these signaling overhead can be saved and are more timely and accurate.

The method proposed in the present application utilizes the capability of network and terminal collaboration, thus achieving better results.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of receiving a first signaling according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of radio signal transmission according to one embodiment of the present application;

FIG. 6 illustrates a schematic diagram of mobility management according to one embodiment of the present application;

FIG. 7 illustrates a schematic diagram of an artificial intelligence processing system according to one embodiment of the present application;

FIG. 8 illustrates a schematic diagram of a generation of second information according to one embodiment of the present application;

FIG. 9 illustrates a schematic diagram of a first encoder according to one embodiment of the present application;

FIG. 10 illustrates a schematic diagram of a first function according to one embodiment of the present application;

FIG. 11 illustrates a schematic diagram of a generation of first location information and first time information depending on a first parameter set according to one embodiment of the present application;

FIG. 12 illustrates a schematic diagram of a first-type generator determining whether a second condition set is met according to one embodiment of the present application;

FIG. 13 illustrates a schematic diagram of a processor in a first node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

Embodiment 1 illustrates a flowchart of receiving a first signaling according to one embodiment of the present application, as shown in FIG. 1. In FIG. 1, each step represents a step, it should be particularly noted that the sequence order of each box herein does not imply a chronological order of steps marked respectively by these boxes.

In Embodiment 1, a first node in the present application receives a first signaling in step 101.

Herein, the first signaling comprises a first RRC information element, the first signaling configures a first condition set and a first time window; there exists a dependency relation between the first condition set and the first time window; an execution of the first RRC information element depends on the first condition set; herein, the first RRC information element configures a target cell of the first node; the meaning of the phrase that an execution of the first RRC information element depends on the first condition set is: when at least one condition in the first condition set is not met, the first RRC information element is not executed; when all conditions in the first condition set are met, the first RRC information element is delayed in execution; the delayed in execution is not later than an end of the first time window.

In one embodiment, the first node is a User Equipment (UE).

In one embodiment, the first node is in RRC_CONNECTED state.

In one subembodiment of the embodiment, the first node is in RRC_CONNECTED state upon receiving the first signaling.

In one subembodiment of the embodiment, when starting the first timer, the first node is in RRC_CONNECTED state or a state other than RRC_CONNECTED state.

In one embodiment, the first node is in non-RRC_CONNECTED state.

In one subembodiment of the embodiment, the first timer is initiated during RRC connection establishment or connection recovery.

In one embodiment, any parameter in the present application can either be configured by the network or generated by the first node based on internal algorithms, such as random ones.

In one embodiment, a value of any parameter in the present application, including but not limited to a value of a timer, a value of a counter, is limited unless specifically stated.

In one subembodiment of the embodiment, an upper bound of a value of any parameter in the present application is 1024 times 65536.

In one subembodiment of the embodiment, an upper bound of a value of any parameter in the present application is 65536 or 65535.

In one subembodiment of the embodiment, an upper bound of a value of any parameter in the present application is 1024.

In one subembodiment of the embodiment, an upper bound of a value of any parameter in the present application is 640 or 320.

In one embodiment, the present application is for NR.

In one embodiment, the present application is for NR-evolved radio communication networks.

In one embodiment, a serving cell refers to a cell where aUE camps; executing a cell search comprises: a UE searches for a suitable cell of a selected Public Land Mobile Network (PLMN) or a Stand-alone Non-Public Network (SNPN), selects the suitable cell to provide available services, and monitors a control channel of the suitable cell, and this procedure is defined as camping on a cell; that is, a camped cell is a serving cell of the UE relative to the UE. Advantages of camping on a cell in RRC_IDLE state or RRC_INACTIVE state: enabling the UE to receive a system message from the PLMN or the SNPN; after registration, if the UE wishes to establish an RRC connection or continue a suspended RRC connection, the UE can achieve this by executing an initial access on a control channel of residing camping cell; the network may page the UE; so that the UE can receive notifications of Earthquake and Tsunami Warning System (ETWS) and Commercial Mobile Alert System (CMAS).

In one embodiment, for a UE in RRC_CONNECTED state that is not configured with carrier aggregation/dual connectivity (CA/DC), only one serving cell comprises a PCell; if a UE is only connected to one cell, then this cell is a main cell of UE. For a UE in RRC_CONNECTED state that is configured with CA/DC, a serving cell is used to indicate a cell set comprising a Special Cell (SpCell) and all sub-cells. The PCell is a cell in a Master Cell Group (MCG), which works at primary frequency, and the UE executes an initial connection establishment procedure or initiates a connection re-establishment on the PCell. For a dual connectivity operation, a Secondary Cell Group (SCG) refers to a PCell of an MCG or a Primary SCG Cell (PSCell) of an SCG; if it is not a dual connectivity operation, an SpCell refers to a PCell.

In one embodiment, a frequency at which a Secondary Cell (SCell) operates is a sub-frequency.

In one embodiment, an individual content of an information element is called a field.

In one embodiment, a Multi-Radio Dual Connectivity (MR-DC) refers to a dual connectivity between an E-UTRA and an NR node, or a dual connectivity between two NR nodes.

In one embodiment, in MR-DC, a radio access node providing a control-plane connection to the core network is a master node, and the master node may be a master eNB, a master ng-eNB, or a master gNB.

In one embodiment, an MCG refers to, in MR-DC, a group of serving cells associated with a master node, comprising an SpCell, and optionally one or multiple SCells.

In one embodiment, a PCell is an SpCell of an MCG.

In one embodiment, a PSCell is an SpCell of an SCG.

In one embodiment, in MR-DC, a control plane connection to the core network is not provided, and a radio access node providing extra resources to the UE is a sub-node. The sub-node can be an en-gNB, a sub-ng-eNB or a sub-gNB.

In one embodiment, in MR-DC, a group of serving cells associated with a sub-node is a Secondary Cell Group (SCG), comprising an SpCell and, optionally, one or multiple SCells.

In one embodiment, the SpCell is a PCell or the SpCell is a PSCell.

In one embodiment, the method proposed in the present application is applicable to both scenarios with SCG configured and scenarios without SCG configured, especially for scenarios without SCG configured.

In one embodiment, an RRC information element refers to an information element in an RRC message.

In one embodiment, SSB can be referred to as SS/PBCH block, or SS block.

In one embodiment, an RRC information element can comprise one or multiple RRC information elements.

In one embodiment, an RRC information element may not comprise any RRC information element, but only comprise at least one parameter.

In one embodiment, a radio bearer comprises at least a signaling radio bearer and a data radio bearer.

In one embodiment, a radio bearer is services provided by the PDCP layer to higher layers or an interface of services.

In one subembodiment of the above embodiment, the higher layer comprises one of the RRC layer, the NAS layer, and the SDAP layer.

In one embodiment, a signaling radio bearer is services provided by PDCP to higher layers or an interface of services.

In one subembodiment of the above embodiment, the higher layer comprises at least former of the RRC layer and the NAS.

In one embodiment, a data radio bearer is services provided by PDCP to higher layers or an interface of services.

In one subembodiment of the above embodiment, the higher layer comprises at least former of the SDAP layer and the NAS.

In one embodiment, the first signaling is an RRC signaling.

In one embodiment, the first signaling is a signaling of the protocol layer above the RRC layer.

In one embodiment, the first signaling is a higher-layer signaling.

In one embodiment, the first signaling is at least partial fields comprising an RRC message.

In one embodiment, the first signaling is only partial fields comprising an RRC message.

In one embodiment, the first signaling is a signaling transmitted on SRB1.

In one embodiment, the first signaling is a signaling transmitted on SRB3.

In one embodiment, the first signaling is an RRC reconfiguration message.

In one embodiment, the first signaling comprises an RRCReconfiguration message.

In one embodiment, the first signaling comprises at least partial fields in an RRCReconfiguration message.

In one embodiment, the first signaling comprises an RRCConnectionReconfiguration message.

In one embodiment, the first signaling comprises an RRCReconfigurationNR message.

In one embodiment, the first signaling comprises an RRCReconfigurationENR message.

In one embodiment, the first signaling is used for handover.

In one embodiment, the first signaling is used for cell switching.

In one embodiment, the first signaling carries the first RRC information element.

In one embodiment, a field of the first signaling carries the first RRC information element.

In one embodiment, the first RRC information element is an information element of the first signaling.

In one embodiment, the first RRC information element comprises at least one information element in an RRCReconfiguration message.

In one embodiment, the first RRC information element comprises only one information element in an RRCReconfiguration message.

In one embodiment, the first RRC information element is carried by an RRCReconfiguration message.

In one embodiment, the first RRC information element is or comprises CellGroupConfig.

In one embodiment, the first RRC information element comprises an RRCReconfiguration message.

In one subembodiment of the embodiment, an RRCReconfiguration message comprised in each RRC information element in the first RRC information element exists in a container.

In one subembodiment of the embodiment, an RRCReconfiguration message carrying the first RRC information element carries an RRCReconfiguration message comprised in the first RRC information element through container.

In one subembodiment of the embodiment, an RRCReconfiguration message comprised in the first RRC information element is from the target cell or candidate cell.

In one embodiment, the first RRC information element configures a cell group.

In one subembodiment of the embodiment, CellGroupConfig comprised in the first RRC information element configures a cell group.

In one embodiment, the meaning of the phrase that the first RRC information element configures a cell group comprises: the first RRC information element configures an SpCell of the cell group, and the target cell is the SpCell of the cell group.

In one embodiment, a cell group configured by the first RRC information element is either a master cell group or a candidate master cell group, or a slave cell group or a candidate slave cell group.

In one embodiment, the meaning of the phrase that the first RRC information element configures a cell group comprises: the first RRC information element configures a value of at least one timer of the cell group.

In one subembodiment of the embodiment, the least one timer comprises T304.

In one subembodiment of the embodiment, the least one timer comprises T310.

In one subembodiment of the embodiment, the first RRC information element configures a value of N310 of the cell group.

In one embodiment, the T310 timer is used for radio link failure, that is, an expiration of T310 triggers radio link failure; the T310 is initiated after receiving a number of N310 of indication(s) from the physical layer, and when an evaluation for radio link quality is below a specific threshold, the physical layer transmits the indication to the higher layer; the specific threshold is either predefined or network-configured.

In one embodiment, the meaning of the phrase that the first RRC information element configures a target cell of the first node comprises: the first RRC information element configures random access resources of the target cell of the first node.

In one subembodiment of the above embodiment, the random access resource comprises at least one of competition-free random access resources and competition-based random access resources.

In one embodiment, the meaning of the phrase that the first RRC information element configures a target cell of the first node comprises: the first RRC information element configures frequency of the target cell of the first node.

In one embodiment, the meaning of the phrase that the first RRC information element configures a target cell of the first node comprises: the first RRC information element configures reference signal resources of the target cell of the first node.

In one embodiment, the meaning of the phrase that the first RRC information element configures a target cell of the first node comprises: the first RRC information element configures a value of a first timer of the target cell of the first node.

In one embodiment, the meaning of the phrase that the first RRC information element configures a target cell of the first node comprises: the first RRC information element configures an RLC bearer or RLC entity of a cell group to which the target cell of the first node belongs.

In one embodiment, the meaning of the phrase that the first RRC information element configures a target cell of the first node comprises: the first RRC information element configures a MAC of a cell group to which the target cell of the first node belongs.

In one embodiment, the meaning of the phrase that the first RRC information element configures a target cell of the first node comprises: the first RRC information element configures an identity or index of the target cell of the first node.

In one embodiment, the meaning of the phrase that the first RRC information element configures a target cell of the first node comprises: the first RRC information element configures an SCell of a cell group to which the target cell of the first node belongs.

In one embodiment, the meaning of the phrase that the first RRC information element configures a target cell of the first node comprises: the first RRC information element configures reconfigurationWithSync of an SpCell of a target cell of the first node.

In one embodiment, the meaning of the phrase that the first RRC information element configures a target cell of the first node comprises: the first RRC information element configures a measurement of a target cell of the first node and/or parameters used for mobility management.

In one embodiment, the meaning of the phrase that the first RRC information element configures a target cell of the first node comprises: configuring the target cell as an SpCell of a cell group of the first node.

In one subembodiment of the embodiment, SpCellConfig in CellGroupConfig comprised in the first RRC information element configures the target cell.

In one subembodiment of the embodiment, the target cell is an SpCell of the cell group.

In one subembodiment of the embodiment, the target cell is a target SpCell in cell switching or LTM (L1L2 triggered Mobility).

In one subembodiment of the embodiment, the target cell is a target SpCell of a cell switching or LTM cell switching.

In one embodiment, a cell group configured by the first RRC information element is one of an MCG and/or SCG.

In one embodiment, the meaning of the phrase that the first signaling configures a first condition set and a first time window comprises: the first signaling indicates a length of the first time window.

In one embodiment, the meaning of the phrase that the first signaling configures a first condition set and a first time window comprises: the first signaling indicates using the first time window.

In one embodiment, the meaning of the phrase that the first signaling configures a first condition set and a first time window comprises: the first signaling indicates a dependency or association relation between the first time window and the first condition set.

In one embodiment, the meaning of the phrase that the first signaling configures a first condition set and a first time window comprises: the first signaling indicates a length of the first time window.

In one embodiment, the meaning of the phrase that the first signaling configures a first condition set and a first time window comprises: the first signaling indicates a timer corresponding to the first time window.

In one embodiment, the meaning of the phrase that the first signaling configures a first condition set and a first time window comprises: the first signaling indicating each condition in the first condition set.

In one subembodiment of the embodiment, each condition in the first condition set is an event.

In one embodiment, the meaning of the phrase that the first signaling configures a first condition set and a first time window comprises: each condition in the first condition set is an event, and the first signaling indicates an entry condition and/or exit condition for each condition in the first condition set.

In one embodiment, the meaning of the phrase that the first signaling configures a first condition set and a first time window comprises: each condition in the first condition set is an event, and the first signaling indicates an entry condition and/or exit condition for each condition in the first condition set.

In one embodiment, the meaning of the phrase that the first signaling configures a first condition set and a first time window comprises: the first signaling indicates a measurement corresponding to each condition in the first condition set.

In one embodiment, the meaning of the phrase that the first signaling configures a first condition set and a first time window comprises: the first signaling indicates a configuration of a measurement or a threshold of a measurement corresponding to each condition in the first condition set.

In one embodiment, the meaning of the phrase that the first signaling configures a first condition set and a first time window comprises: a report configuration field of the first signaling configures at least one of the first condition set or the first time window.

In one embodiment, the meaning of the phrase that the first signaling configures a first condition set and a first time window comprises: the first signaling comprises parameters for each condition in the first condition set.

In one embodiment, each condition in the first condition set is configured by the network.

In one embodiment, all conditions configured by the network to determine whether to execute the first RRC information element belong to the first condition set.

In one subembodiment of the embodiment, the configured by the network refers to explicitly configured.

In one embodiment, the first condition set comprises all conditions configured by the network to determine whether to execute the first RRC information element.

In one subembodiment of the embodiment, the configured by the network refers to explicitly configured.

In one embodiment, the first signaling configures the first condition set and the first time window within a field.

In one embodiment, conditions of the first condition set are all based on measurement events.

In one embodiment, the first time window starts when all conditions in the first condition set are met.

In one embodiment, a length of the first time window is finite.

In one embodiment, a length of the first time window is not longer than 48 hours.

In one embodiment, a length of the first time window is not longer than a few minutes.

In one embodiment, a length of the first time window is not longer than 65536 seconds.

In one embodiment, a length of the first time window is not longer than 1024 seconds.

In one embodiment, a length of the first time window is not longer than 65536 milliseconds.

In one embodiment, a length of the first time window is not longer than 10240 milliseconds.

In one embodiment, a length of the first time window is not longer than 1024 milliseconds.

In one embodiment, a length of the first time window is not longer than 640 milliseconds.

In one embodiment, a length of the first time window is not longer than 320 milliseconds.

In one embodiment, a length of the first time window is not longer than an end time of the day.

In one embodiment, the first time window is a running period of a first timer.

In one embodiment, a length of the first time window is not less than 1 millisecond.

In one embodiment, a length of the first time window is not less than 10 milliseconds.

In one embodiment, a length of the first time window is not less than one slot.

In one embodiment, a length of the first time window is not less than one DRX period.

In one embodiment, a length of the first time window is not less than 1.5 DRX cycles.

In one embodiment, a length of the first time window is not less than multiple DRX cycles, such as 2, 4, 8, 16.

In one embodiment, a length of the first time window is not less than 20 milliseconds.

In one embodiment, a length of the first time window is not less than 40 milliseconds.

In one embodiment, a length of the first time window is not less than 80 milliseconds.

In one embodiment, the target cell is a different cell from a transmitter of the first signaling.

In one embodiment, the target cell is a target cell in switching.

In one embodiment, the target cell is an SpCell.

In one embodiment, the target cell is a new SpCell.

In one embodiment, the target cell is a target cell in mobility management.

In one embodiment, the target cell belongs to a same base station as a transmitter of the first signaling.

In one embodiment, the target cell belongs to a same control unit (CU) as a transmitter of the first signaling.

In one embodiment, the target cell belongs to different control units (CUs) as a transmitter of the first signaling.

Typically, a control unit manages multiple cells.

In one embodiment, the target cell has a signaling interface with a transmitter of the first signaling.

In one subembodiment of the embodiment, the signaling interface is an Xn interface.

In one subembodiment of the embodiment, the signaling interface is an interface between a cell, a base station or a CU.

In one embodiment, a generation of the first RRC information element is the target cell.

In one subembodiment of the embodiment, a transmitter of the first signaling forwards the first RRC information element generated by the target cell.

In one embodiment, in this field, the meaning of the target cell is not that a configured cell can be called a target cell, but specifically refers to a target cell in mobility management.

In one embodiment, the first condition set is a lowest or most conservative condition under which the first RRC information element is executed.

In one embodiment, the meaning of the phrase that when at least one condition in the first condition set is not met, the first RRC information element is not executed is: the first node evaluates whether all conditions in the first condition set are met, and only when all conditions in the first condition set are met, the first node evaluates whether to execute or delay the execution of the first RRC information element.

In one embodiment, the meaning of the phrase that when at least one condition in the first condition set is not met, the first RRC information element is not executed is: the first node evaluates whether all conditions in the first condition set are met, and only when all conditions in the first condition set are met, the first node evaluates whether to execute or delay the execution of the first RRC information element.

In one embodiment, the meaning of the phrase that when at least one condition in the first condition set is not met, the first RRC information element is not executed is: the first node evaluates whether all conditions in the first condition set are met, and when at least one condition in the first condition set is not met, the first node does not evaluate whether to execute or delay the execution of the first RRC information element.

In one embodiment, the meaning of the phrase that when at least one condition in the first condition set is not met, the first RRC information element is not executed is: the first node evaluates whether all conditions in the first condition set are met, and when at least one condition in the first condition set is not met, an execution or evaluation execution for the first RRC information element is terminated.

In one embodiment, the meaning of the phrase that when at least one condition in the first condition set is not met, the first RRC information element is not executed is: the first node evaluates whether all conditions in the first condition set are met, and when at least one condition in the first condition set is not met, an evaluation for the first condition set is terminated.

In one embodiment, only when an evaluation of the first condition set is complete, an execution of the first RRC information element may be triggered.

In one subembodiment of the embodiment, a result of an evaluation of the first condition set is that all conditions in the first condition set are met.

In one embodiment, the first condition set only comprises a condition.

In one embodiment, the first condition set comprises multiple conditions.

In one embodiment, each condition in the first condition set is an event.

In one embodiment, a name of the event can be represented as Ax, where A is identifier.

In one subembodiment of the above embodiment, x is a positive integer not greater than 20.

In one embodiment, a name of the event can be represented as Lx, where L is identifier.

In one subembodiment of the above embodiment, x is a positive integer not greater than 20.

In one embodiment, a name of the event can be represented as Tx, where T is identifier.

In one subembodiment of the above embodiment, x is a positive integer not greater than 20.

In one embodiment, the first condition set comprises an A3 event.

In one embodiment, the first condition set comprises an A4 event.

In one embodiment, the first condition set comprises an A5 event.

In one embodiment, the first condition set comprises an L1 event.

In one embodiment, the first condition set comprises a T1 event.

In one embodiment, the meaning of delayed in execution comprises: the first node is allowed to execute.

In one embodiment, the meaning of delayed in execution comprises: the first node is allowed to decide for itself when to execute.

In one embodiment, the meaning of delayed in execution comprises: it may not be executed immediately.

In one embodiment, the meaning of delayed in execution comprises: determining when to execute based on the implementation of the first node.

In one embodiment, the meaning of delayed in execution comprises: determining when to execute based on conditions that are not explicitly configured by the network.

In one embodiment, the meaning of delayed execution does not comprise: the need to receive a new indication, which indicates to execute the first RRC information element.

In one embodiment, a time interval between the first condition set being met and the execution of the first RRC information element is not fixed.

In one embodiment, a time interval between the first condition set being met and the execution of the first RRC information element is determined by the first node.

In one embodiment, a time interval between the first condition set being met and the execution of the first RRC information element is self-determined by the first node.

In one embodiment, a time interval between the first condition set being met and the execution of the first RRC information element is not network configured or pre-configured.

In one embodiment, a time interval between the first condition set being met and the execution of the first RRC information element is not indicated by the first signaling.

In one embodiment, benefits of the above method is: it can be more flexible and more accurate to determine the best time to execute the first RRC information element; at the same time, it is helpful to reduce the complexity and difficulty of network implementation; avoiding a stereotypical programmed execution of the first RRC information element, including that a first RRC information element must be executed immediately after a first condition set is met, and that the first RRC information element must be executed at a fixed time after the first condition set is met, this is precisely the problem that the present application seeks to address.

In one embodiment, the first RRC information element is not executed and at least one condition in the first condition set is no longer met, the first RRC information element is not executed.

In one embodiment, the meaning of the phrase that there exists a dependency relation between the first condition set and the first time window is: the first condition set depending on the first time window.

In one subembodiment of the embodiment, the first condition set is valid only within the first time window.

In one subembodiment of the embodiment, the first condition set is configured to the first time window.

In one subembodiment of the embodiment, the first condition set is evaluated only within the first time window.

In one subembodiment of the embodiment, the first time window starts upon receiving the first signaling.

In one subembodiment of the embodiment, the first signaling indicates a start time of the first time window, or indicates when the first time window begins.

In one subembodiment of the embodiment, the first signaling is configured with a third condition set and a second time window, and the third condition set depends on the second time window; an execution of the first RRC information element depends on the third condition set; the meaning of the phrase that an execution of the first RRC information element depends on the third condition set is: when at least one condition in the third condition set is not met, the first RRC information element is not executed; when all conditions in the third condition set are met, the first RRC information element is executed immediately or delayed to be executed.

In one subsidiary embodiment of the above subembodiment, the delayed execution is not later than an end of the second time window.

In one subsidiary embodiment of the above subembodiment, the first time window and the second time window are non-overlapping.

In one subsidiary embodiment of the above subembodiment, the third condition set comprises at least one condition.

In one subsidiary embodiment of the above subembodiment, a length of the second time window is finite, for example, not longer than 65536 ms.

In one subsidiary embodiment of the above subembodiment, the third condition set is valid only within the second time window.

In one subsidiary embodiment of the above subembodiment, the first signaling indicates, when all conditions in the third condition set are met, whether the first RRC information element is executed immediately or delayed to be executed.

In one embodiment, benefits of the above method include: it is beneficial to configure different conditions at different times, so that the control of the execution of the first RRC information element is more targeted and more adaptive, for example, in a second time window, the execution of the first RRC information element depends on the third condition set; it is beneficial to save power, i.e. the first condition set does not need to be evaluated over the entire time period, but only within the first time window.

In one embodiment, the meaning of the phrase that there exists a dependency relation between the first condition set and the first time window is: the first time window depends on the first condition set.

In one subembodiment of the embodiment, a beginning of the first time window depends on the first condition set being met.

In one subembodiment of the embodiment, when the first condition set is met, the first time window begins.

In one subembodiment of the embodiment, when the first condition set is met, a first timer is started, and a running period of the first timer corresponds to the first time window.

In one subembodiment of the embodiment, the meaning of the first condition set being met is that all conditions in the first condition set are met.

In one subembodiment of the embodiment, at a fixed time after the first condition set is met, the first time window begins.

In one subembodiment of the embodiment, the first signaling indicates the fixed time, for example, 4 ms, 10 ms, 5 ms.

In one subembodiment of the embodiment, a delay of a fixed and finite time length after the first condition set is met, start the first time window.

In one subembodiment of the embodiment, an end of the first time window depends on the first condition set.

In one subembodiment of the embodiment, when the first condition set is no longer met, the first time window ends.

In one subembodiment of the embodiment, the first signaling indicates a length of the first time window.

In one embodiment, benefits of the above method include: the execution of the first RRC information element by the network is controllable, that is, the first node is not allowed to decide whether to execute the first RRC information element by itself without limitation, which is conducive to reducing the inconsistency between the network and the first node, so as to avoid the occurrence of accidents.

Typically, the first condition set will not always be met, nor will it ever be met.

In one embodiment, the first signaling comprises first indication information.

In one subembodiment of the embodiment, the first indication information indicates that when all conditions in the first condition set are met, the first RRC information element is allowed to be delayed in execution.

In one subembodiment of the embodiment, the first indication information indicates when all conditions in the first condition set are met, and whether the first RRC information element is executed immediately or delayed to be executed.

In one subembodiment of the embodiment, the first indication information occupies 1 bit.

In one subembodiment of the embodiment, the first signaling indicates that when all conditions in the first condition set are met, the first RRC information element is allowed to be delayed.

In one embodiment, when the first indicator information is established, it indicates that when all conditions in the first condition set are met, the first RRC information element is delayed in execution.

In one embodiment, when the first signaling does not comprise the first indication information, when all conditions in the first condition set are indicated to be met, the first RRC information element is executed immediately.

In one embodiment, the meaning of delayed in execution comprises: when all conditions in the first condition set are met, and only when the second condition set is met, the first RRC information element is executed; the second condition set is not explicitly indicated.

In one embodiment, the second condition set is not explicitly configured.

In one embodiment, the second condition set is orthogonal to the first condition set.

In one embodiment, the second condition set is not configured.

In one embodiment, the first signaling does not comprise the second condition set.

In one embodiment, the second condition set is determined by the first node itself.

In one embodiment, none of the conditions in the second condition set is an event.

In one embodiment, the second condition set is based on the implementation of the first node.

In one embodiment, which conditions comprised in the second condition set is self-determined by the first node.

In one embodiment, benefits of the above method include: increasing the flexibility, allowing the terminal to determine whether and when to execute the first RRC information element based on implementation.

In one embodiment, the second condition set comprises at least one condition.

In one embodiment, when the first condition set is met, and when the second condition set is met, the first RRC information element is executed immediately.

In one embodiment, the second condition set comprises at least one prediction-based condition.

In one embodiment, the prediction is a prediction executed by the first node.

In one embodiment, the first condition set depends on a first configuration of a first-type measurement parameter; the second condition depends on a second configuration of the first-type measurement parameter.

In one embodiment, the first-type measurement parameter comprises TTT (time to trigger).

In one embodiment, the first-type measurement parameter comprises hysteresis.

In one embodiment, the first-type measurement parameter comprises a filter.

In one embodiment, the first-type measurement parameter comprises accuracy of measurement.

In one embodiment, the first-type measurement parameter comprises frequency of measurement.

In one embodiment, the first-type measurement parameters comprise a measurement period or frequency.

In one subembodiment of the above embodiment, the filter comprises a layer-1 filter and a layer-3 filter.

In one subembodiment of the above embodiment, the filter comprises parameters of filter.

In one embodiment, the first configuration of the first-type measurement parameter and the second configuration of the first-type measurement parameter are different configuration values for a same measurement configuration item, for example, for TTT, the first configuration is 10 ms and the second configuration is 5 ms.

In one embodiment, benefits of the above method include: reducing power consumption and reducing signaling overhead, the first node can use a more granular measurement configuration upon judging whether to execute the first RRC information element without having to report those measurements to the network, which reduces signaling overhead, on the other hand, when the first condition set is not met, executing measurements with large granularity saves power.

In one embodiment, the prediction comprises a prediction of at least one channel quality, handover failure probability, handover success probability, interruption probability, throughput rate, or quality of user experience.

In one subembodiment of the embodiment, the first signaling indicates to which item or items the prediction is directed.

In one subembodiment of the embodiment, the first signaling indicates weight of at least one item in the embodiment.

In one embodiment, the prediction is based on training.

In one embodiment, the prediction is based on measurement.

In one embodiment, the prediction is based on user habits.

In one embodiment, the prediction is based on user emotions.

In one embodiment, the prediction is based on artificial intelligence.

In one embodiment, the second condition set comprises at least one of being at a location determined by the first location information and being within a time determined by first time information.

In one embodiment, the first location information is determined by the first node.

In one embodiment, the first time information is determined by the first node.

In one embodiment, the first node determines the first location information and/or the first time information based on historical information.

In one embodiment, the first node determines the first location information and/or the first time information based on training or machine learning.

In one embodiment, the first node determines the first location information and/or the first time information based on simulation.

In one embodiment, the first node determines the first location information based on map.

In one embodiment, the first node determines the first time information based on motion speed and expected motion speed.

In one embodiment, the first location information determines the first time information.

In one embodiment, the first node determines the first time information according to service quality requirements.

In one embodiment, the first signaling comprises multiple RRC information elements, the first RRC information element is one of the multiple RRC information elements, and each of the multiple RRC information elements is associated with a condition set, and when a condition set associated with any of the multiple RRC information elements is not met, the any RRC information element in the multiple RRC information elements is not executed; when a condition set associated with any of the multiple RRC information elements is met, an execution of the any RRC information element in the multiple RRC information elements is delayed.

In one embodiment, the first signaling indicates a condition set associated with any of the multiple RRC information elements.

In one embodiment, the first RRC information element is any of the multiple RRC information elements.

In one embodiment, any RRC information element in the multiple RRC information elements configures a target cell or a candidate cell for the target cell.

In one embodiment, any RRC information element in the multiple RRC information elements is configured as a cell group.

In one subembodiment of the embodiment, all information elements in the multiple RRC information elements are independently and completely configured in a same cell group.

In one embodiment, benefits of the above method include: multiple candidate cells can be configured in handover, which increases the success rate of handover.

### Embodiment 2

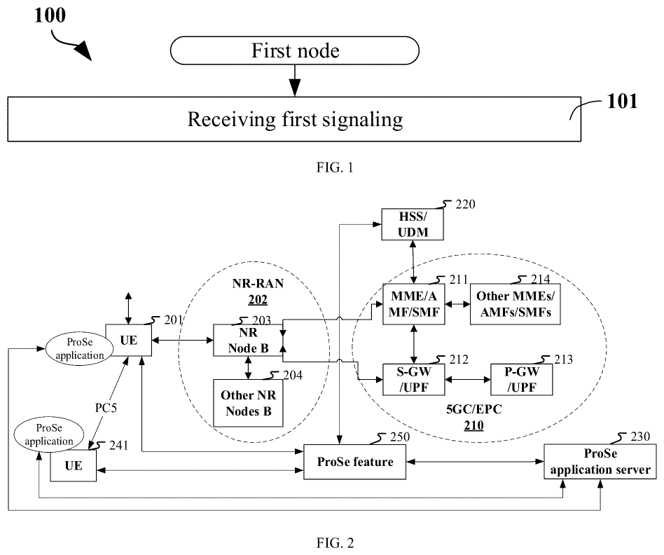

Embodiment 2 illustrates a schematic diagram of a network architecture according to the present application, as shown in FIG. 2.

FIG. 2 illustrates a network architecture 200 of 5G NR, Long-Term Evolution (LTE) and Long-Term Evolution Advanced (LTE-A) systems. The 5G NR or LTE network architecture 200 may be called a 5G System (5GS)/Evolved Packet System (EPS) 200 or other appropriate terms. The 5GS/EPS 200 may comprise one or more UEs 201, an NG-RAN 202, a 5G Core Network/Evolved Packet Core (5GC/EPC) 210, a Home Subscriber Server (HSS)/Unified Data Management (UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will readily understand that various concepts presented throughout the present application can be extended to networks providing circuit switching services or other cellular networks. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of the UE 201 include cellular phones, smart phones, Session Initiation Protocol (SIP) phones, laptop computers, Personal Digital Assistant (PDA), non-terrestrial base station communication, Global Positioning Systems (GPSs), multimedia devices, video devices, digital audio players (for example, MP3 players), cameras, game consoles, unmanned aerial vehicles (UAV), aircrafts, narrow-band physical network devices, machine-type communication devices, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an Sl/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the first node in the present application is UE 201.

In one embodiment, a base station of the second node in the present application is gNB 203.

In one embodiment, a wireless link from the UE 201 to NR node B is an uplink.

In one embodiment, a wireless link from NR node B to UE 201 is a downlink.

In one embodiment, the UE 201 comprises a mobile phone.

In one embodiment, the UE 201 is a vehicle comprising a car.

In one embodiment, the gNB 203 is a MarcoCellular base station.

In one embodiment, the gNB 203 is a Micro Cell base station.

In one embodiment, the gNB 203 is a Pico Cell base station.

### Embodiment 3

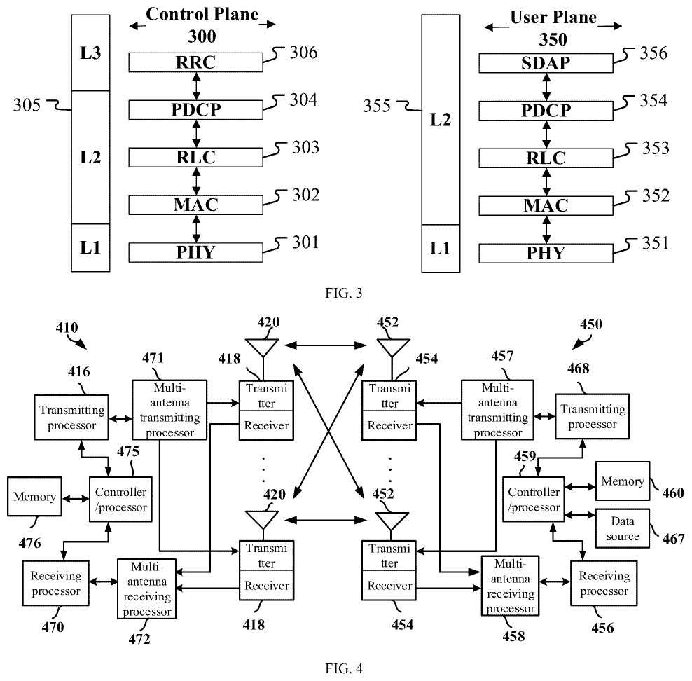

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first node (UE or gNB) and a second node (gNB or UE) or between two UEs is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of a link between a first node and a second node, as well as two UEs via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second node. The PDCP sublayer 304 provides multiplexing among variable radio bearers and logical channels. The PDCP sublayer 304 provides security by encrypting a packet and provides support for a first node handover between second nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second node and a first node. PC5 Signaling Protocol (PC5-S) sublayer 307 is responsible for the processing of signaling protocol at PC5 interface. The radio protocol architecture of the user plane 350 comprises layer 1 (L1) and layer 2 (L2). In the user plane 350, the radio protocol architecture for the first node and the second node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. SRB can be seen as a service or interface provided by the PDCP layer to a higher layer, such as the RRC layer. In NR system, SRB comprises SRB1, SRB2, SRB3, which is respectively used to transmit different types of control signalings. SRB, a bearer between a UE and access network, is used to transmit a control signaling, comprising an RRC signaling, between UE and access network. SRB1 has special significance for a UE. After each UE establishes an RRC connection, there will be SRB1 used to transmit RRC signaling. Most of the signalings are transmitted through SRBL. If SRB1 is interrupted or unavailable, the UE must perform RRC reconstruction. SRB2 is generally used only to transmit an NAS signaling or signaling related to security aspects. UE cannot configure SRB3. Except for emergency services, a UE must establish an RRC connection with the network for subsequent communications. Although not described in the figure, the first node may comprise several higher layers above the L2 305. also comprises a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first signaling in the present application is generated by the RRC 306.

In one embodiment, the first information in the present application is generated by the RRC 306.

In one embodiment, the second signaling in the present application is generated by the RRC 306.

### Embodiment 4

Embodiment 4 illustrates a schematic diagram of a first communication device and a second communication device according to one embodiment of the present application, as shown in FIG. 4. FIG. 4 is a block diagram of a first communication device 450 in communication with a second communication device 410 in an access network.

The first communication device 450 comprises a controller/processor 459, a memory 460, a data source 467, a transmitting processor 468, a receiving processor 456, optionally may also comprise a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, optional can also comprise a multi-antenna receiving processor 472, a multi-antenna transmitting processor 471, a transmitter/receiver 418 and an antenna 420.

In a transmission from the second communication device 410 to the first communication device 450, at the first communication device 410, a higher layer packet from the core network is provided to a controller/processor 475. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transport channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first communication device 450 comprises: at least one processor and at least one memory. The at least one memory comprises computer program codes; the at least one memory and the computer program codes are configured to be used in collaboration with the at least one processor, the first communication device 450 at least: receives a first signaling, the first signaling comprises a first RRC information element, the first signaling configures a first condition set and a first time window; there exists a dependency relation between the first condition set and the first time window; an execution of the first RRC information element depends on the first condition set; herein, the first RRC information element configures a target cell of the first node; the meaning of the phrase that an execution of the first RRC information element depends on the first condition set is: when at least one condition in the first condition set is not met, the first RRC information element is not executed; when all conditions in the first condition set are met, the first RRC information element is delayed in execution; the delayed in execution is not later than an end of the first time window.

In one embodiment, the first communication device 450 comprises at least one processor and at least one memory. a memory that stores a computer readable instruction program. The computer readable instruction program generates an action when executed by at least one processor. The action includes: receiving a first signaling, the first signaling comprising a first RRC information element, the first signaling configuring a first condition set and a first time window; there existing a dependency relation between the first condition set and the first time window; an execution of the first RRC information element depending on the first condition set; herein, the first RRC information element configures a target cell of the first node; the meaning of the phrase that an execution of the first RRC information element depends on the first condition set is: when at least one condition in the first condition set is not met, the first RRC information element is not executed; when all conditions in the first condition set are met, the first RRC information element is delayed in execution; the delayed in execution is not later than an end of the first time window.

In one embodiment, the first communication device 450 corresponds to a first node in the present application.

In one embodiment, the second communication device 410 corresponds to a second node in the present application.

In one embodiment, the first communication device 450 is a UE.

In one embodiment, the first communication device 450 is a vehicle terminal.

In one embodiment, the first communication device 450 is a mobile.

In one embodiment, the second communication device 410 is an aircraft.

In one embodiment, the second communication device 410 is a base station.

In one embodiment, the receiver 454 (comprising the antenna 452), the receiving processor 456 and the controller/processor 459 are used to receive the first signaling in the present application.

In one embodiment, the receiver 454 (comprising the antenna 452), the receiving processor 456 and the controller/processor 459 are used to receive the second signaling in the present application.

In one embodiment, the transmitter 454 (comprising antenna 452), the transmitting processor 468 and the controller/processor 459 are used to transmit the first information in the present application.

### Embodiment 5

Embodiment 5 illustrates a flowchart of radio signal transmission according to one embodiment in the present application, as shown in FIG. 5. In FIG. 5, U01 corresponds to a first node in the present application. It is particularly underlined that the order illustrated in the embodiment does not put constraints over sequences of signal transmissions and implementations; the steps within F51 and F52 are optional.

The first node U01 transmits first information in step S5101; receives a second signaling in step S5102; receives a first signaling in step S5103; evaluates whether a first condition set is met in step S5104; delays an execution of a first RRC information element in step S5105.

The second node U02 receives first information in step S5201; transmits a second signaling in step S5202; transmits a first signaling in step S5202.

In embodiment 5, the first signaling comprises a first RRC information element, the first signaling configures a first condition set and a first time window; there existing a dependency relation between the first condition set and the first time window; an execution of the first RRC information element depending on the first condition set; herein, the first RRC information element configures a target cell of the first node; the meaning of the phrase that an execution of the first RRC information element depends on the first condition set is: when at least one condition in the first condition set is not met, the first RRC information element is not executed; when all conditions in the first condition set are met, the first RRC information element is delayed in execution; the delayed in execution is not later than an end of the first time window.

In one embodiment, the second node U02 is a base station.

In one embodiment, the second node U02 is a network device.

In one embodiment, the second node U02 is a source cell of the first node U01.

In one embodiment, the second node U02 is a source SpCell of the first node U01.

In one embodiment, the second node U02 is a PCell group of the first node U01.

In one embodiment, regardless of whether the first condition set is met, content of the first signaling is applicable.

In one embodiment, content comprised in the first signaling is applicable to whether the first condition set is met.

In one embodiment, step S5101 is taken before step S5102.

In one embodiment, step S5102 is taken before step S5103.

In one embodiment, step S5103 is taken before step S5104.

In one embodiment, step S5104 is taken before step S5105.

In one embodiment, step S5201 is taken before step S5202.

In one embodiment, step S5202 is taken before step S5103.

In one embodiment, the meaning of the first condition set being met is that all conditions in the first condition set are met.

In one embodiment, the meaning of the first condition set not being met is that at least one condition in the first condition set is not met.

In one embodiment, step S5104 in FIG. 5 is evaluated continuously, i.e., the first condition set is evaluated continuously.

In one subembodiment of the embodiment, when the first condition set depends on the first time window, the first node U01 continuously evaluates the first condition set within the first time window.

In one embodiment, in step S5104, when the first condition set is not met, the first node U01 consistently evaluates/continues to evaluate whether the first condition set is met.

In one subembodiment of the embodiment, when the first condition set depends on the first time window, the first node U01 consistently evaluates/continuously evaluates the first condition set within the first time window.

In one embodiment, the first information indicates a first capability.

In one subembodiment of the embodiment, the first capability supports a delayed execution for the first RRC information element.

In one subembodiment of the embodiment, the first signaling depends on the first capability.

In one embodiment, the first information comprises an RRC message.

In one embodiment, the first information indicates radio access capability of the first node U01.

In one embodiment, the first information comprises UECapabilityInformation.

In one embodiment, the first information indicates the first capability and a capability other than the first capability.

In one embodiment, the first information indicates a computing capability of the first node U01.

In one embodiment, the first information comprises an identity or index of the first capability.

In one embodiment, the first information comprises a first reference capability, and the first reference capability is used to determine the first capability.

In one embodiment, the first information indicates whether the first capability is supported.

In one embodiment, the first information indicates at least one parameter of the first capability.

In one embodiment, the meaning of the phrase that the first signaling depends on the first capability comprises: if the first node U01 does not indicate supporting the first capability, the second node U02 will not transmit the first signaling.

In one embodiment, the meaning of the phrase that the first signaling depends on the first capability comprises: if the first node U01 indicates that not supporting the first capability, the second node U02 will not transmit the first signaling.

In one embodiment, the meaning of the phrase that the first signaling depends on the first capability comprises: only if the first node U01 indicates that the first capability is supported, the second node U02 will transmit the first signaling.

In one embodiment, the meaning of the phrase that the first signaling depends on the first capability comprises: if the first node U01 indicates not supporting the first capability, the first indication information of the first signaling indicates that the first RRC information element is executed immediately when the first condition set is met.

In one embodiment, the meaning of the phrase that the first signaling depends on the first capability comprises: if the first node U01 indicates supporting the first capability, the first indication information of the first signaling indicates that an execution of the first RRC information element is allowed to be delayed when the first condition set is met.

In one embodiment, the network may also obtain by other means whether the first node U01 supports the first capability, e.g. whether the first node U01 supports the first capability being present in the data block of the operator, e.g. the first node U01 is provided by the operator, related information is provided to the network at the time of registration for entry into the network, and the network only supports terminals with the first capability, requesting access to such a network implies that such a capability is supported and therefore reporting the first capability is optional.

In one embodiment, advantages of the above embodiments are: the user can control whether the first capability is supported, or whether to report to the network whether the first capability is supported, for more flexibility.

In one embodiment, the first information indicates a second capability;

In one subembodiment of the embodiment, the second capability supports a first-type generator.

In one subembodiment of the embodiment, the first-type generator depends on training.

In one subembodiment of the embodiment, the first-type generator determines whether the first condition is met.

In one embodiment, the second capability is related to artificial intelligence.

In one embodiment, the second capability is related to machine learning.

In one embodiment, the second capability is related to neural networks.

In one embodiment, the second capability is related to prediction.

In one embodiment, the first-type generator comprises the second processor in embodiment 7.

In one embodiment, the first-type generator comprises the third processor in embodiment 7.

In one embodiment, the first-type generator comprises a first encoder in embodiment 7.

In one embodiment, the first-type generator comprises a first function in embodiment 9.

In one embodiment, the first-type generator generates the first condition.

In one embodiment, the first-type generator generates a candidate value of the first timer.

In one embodiment, the first-type generator generates the first value.

In one embodiment, the first-type generator generates the second value.

In one embodiment, the first-type generator is related to artificial intelligence.

In one embodiment, the first-type generator is related to machine learning.

In one embodiment, the first-type generator is related to neural networks.

In one embodiment, the first-type generator is used for prediction.

In one embodiment, the first-type generator generates the second value according to at least one of the first location information or the first time information.

In one embodiment, the first-type generator generates a result of whether the first condition is met.

In one embodiment, the first-type generator generates a result of whether the first condition is met according to at least one of the first location information or the first time information.

In one embodiment, the first-type generator generates the first time information according to the first location information.

In one embodiment, the first-type generator generates the first location information according to the first time information.

In one embodiment, training of the first-type generator is offline.

In one embodiment, training of the first-type generator is online.

In one embodiment, training of the first-type generator is based on past data.

In one embodiment, training of the first-type generator is based on an input of the second node U02.

In one embodiment, the first node U01 indicates whether the first-type generator has been trained.

In one subembodiment of the embodiment, the first node U01 indicates to the second node U02 whether the first-type generator has been trained.

In one subembodiment of the embodiment, the first node U01 indicates to the second node U02 whether the first generator has been trained.

In one subembodiment of the embodiment, the first node U01 requests training for the first generator.

In one embodiment, the first node U01 indicates whether the first-type generator is available.

In one subembodiment of the embodiment, the first node U01 indicates to the second node U02 whether the first-type generator has been trained.

In one subembodiment of the embodiment, the first node U01 indicates to the second node U02 whether the first generator has been trained.

In one subembodiment of the embodiment, the first node U01 requests training for the first generator.

In one embodiment, the first generator belongs to the first-type generator.

In one embodiment, the first generator determines whether the second condition set is met or whether the first RRC information element should be executed.

In one subembodiment of the above embodiment, the first condition set has been met.

In one subembodiment of the above embodiment, a comparison of a result of the first generator with a threshold is used to determine whether the second condition set is met, or to determine whether the first RRC information element is executed.

In one subsidiary embodiment of the above subembodiment, the threshold is determined by the first node U01 or is determined by the second node U02 and is indicated to the first node U01.

In one subsidiary embodiment of the above subembodiment, if a result output by the first generator is greater than the threshold, the second condition is not met, or the first RRC information element is not executed.

In one subsidiary embodiment of the above subembodiment, if a result output by the first generator is not greater than the threshold, the second condition set is met, or it is determined that the first RRC information element should be executed.

In one subembodiment of the embodiment, a confidence level of an output of the first generator is used to determine whether the first condition is met.

In one subembodiment of the embodiment, information entropy or entropy of information output by the first generator is used to determine whether the first condition is met.

In one subembodiment of the embodiment, a residual of an output of the first generator is used to determine whether the first condition is met.

In one subembodiment of the embodiment, a convergence of an output of the first generator is used to determine whether the first condition is met.

In one embodiment, the first generator estimates channel state of the first node U01.

In one embodiment, the first generator predicts channel state of the first node U01.

In one embodiment, advantages of the above approach comprise that the network can be more aware of the capabilities of the first node U01, which facilitates more rational configuration of the first condition set, for example, the first condition set can be further relaxed when the second capability of the first node U01, such as the prediction or computing capability related to artificial intelligence, is strong, otherwise the first condition set needs to be more refined or adjusted according to the situation; the network may also determine whether the first RRC information element is allowed to be delayed based on the second capability supported by the first node U01.

In one embodiment, at least one of the first location information or the first time information is used as an input of the first generator.

In one embodiment, the first signaling and the second signaling belong to a same RRC message.

In one embodiment, the first signaling and the second signaling belong to different RRC messages.

In one embodiment, the second signaling depends on the first capability.

In one embodiment, the second signaling depends on the second capability.

In one embodiment, the second signaling precedes the first signaling.

### Embodiment 6

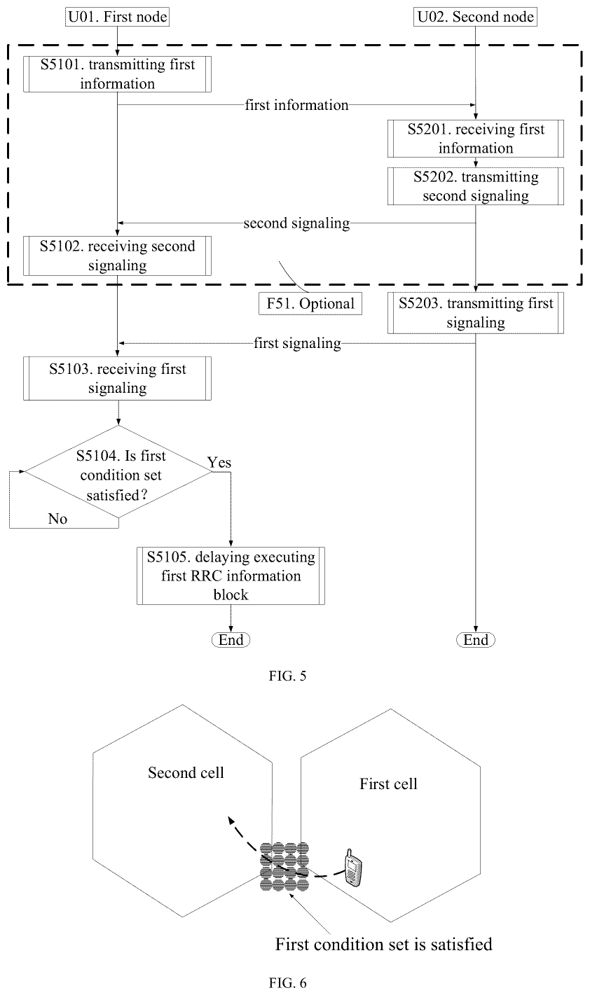

Embodiment 6 illustrates a schematic diagram of mobility management according to one embodiment of the present application, as shown in FIG. 6. The mobile phone in FIG. 6 corresponds to the first node of the present application, the dashed line with an arrow indicates the moving path of the first node.

In one embodiment, a first cell in FIG. 6 is a transmitter of the first signaling; a second cell is the target cell.

In one embodiment, the black shaded region in FIG. 6 indicates a location determined by first location information.

In one embodiment, the black shaded region in FIG. 6 indicates an area where the first node may be located within a delay time during which the first RRC information element is delayed to be executed.

In one embodiment, the first condition set is met in the black shaded region shown in FIG. 6.

In one subembodiment of the above embodiment, the first condition set is related to channel quality.

In one subembodiment of the above embodiment, the first condition set is related to channel quality of the target cell.

In one subembodiment of the above embodiment, after the first node enters the black region in FIG. 6, the execution of the first RRC information element is determined based on whether the second condition set is met.

In one subembodiment of the above embodiment, any location of the first node in the black region in FIG. 6 allows an execution of the first RRC information element.

In one subembodiment of the above embodiment, when the first condition set is not met, the first node does not evaluate whether the second condition set is met.

In one subembodiment of the above embodiment, the first node evaluates whether the second condition set is met only after the first condition set is met.

In one subembodiment of the above embodiment, advantages of the above methods include saving power and saving processing power.

In one embodiment, the black shadow region in FIG. 6 corresponds to a possible motion region of the first node within the first time window after a first condition set is met.

In one embodiment, the present application does not restrict the shape of the shaded region in FIG. 6.

In one embodiment, the shaded region shown in FIG. 6 can also comprise multiple sub-regions.

In one subembodiment of the above embodiment, the multiple sub-regions are adjacent.

In one subembodiment of the above embodiment, the multiple sub-regions may be disjointed.

In one subembodiment of the above embodiment, shape and/or size of the multiple sub-regions are consistent.

In one subembodiment of the above embodiment, the shape and/or size of the multiple sub-regions are not required to be consistent.

In one embodiment, the present application does not restrict the shape of the motion trajectory.

In one embodiment, both the second condition set and the second condition set being met is self-determined by the first node.

In one embodiment, the first location information identifies a sub-region of the black-shaded region in FIG. 6.

In one embodiment, the second condition set is or comprises: the first node is in a location determined by the first location information and/or within a time determined by the first time information.

In one embodiment, the first location information and the first time information are not explicitly indicated by the network.

In one embodiment, the first location information indicates a location through at least one index.

In one subembodiment of the embodiment, the index is an index of a region, or an index of a reference signal or reference signal resources.

In one embodiment, the first location information indicates a location through at least one coordinate.

In one embodiment, the first location information indicates a region through multiple coordinates.

In one embodiment, in FIG. 6, the first cell is a transmitter of the first signaling.

In one embodiment, in FIG. 6, the first node moves from the first cell, and the first node estimates the motion trajectory.

In one subembodiment of the above embodiment, the first node generates the first location information.

In one subembodiment of the above embodiment, the first node generates the first time information.

In one subembodiment of the embodiment, the first node generates the first location information and the first time information.

In one embodiment, the first location information comprises location information at different times.

In one embodiment, the first location information depends on a time determined by the first time information.

In one embodiment, the first location information depends on the first time information.

In one embodiment, the first location information comprises a time-varying position.

In one subembodiment of the embodiment, the time-varying location depends on a time determined by the first time information.

In one embodiment, the first location information comprises multiple location sub-information.

In one subembodiment of the embodiment, any of the multiple location sub-information indicates a sub-region.

In one subembodiment of the embodiment, which location sub-information is selected in the multiple location sub-information depends on a time determined by the first time information.

In one subembodiment of the embodiment, advantages of the embodiment comprise: better supporting time-varying environment, i.e. the location sub-information selected from first location information can be different at different times and therefore being more accurate.

In one embodiment, the first parameter set indicated by the second signaling is input into an encoder maintained by the first node to generate the first location information.

In one embodiment, the first node does not trigger radio link failure within a location determined by the first location information in FIG. 6.

In one embodiment, in FIG. 6, the first node leaves a location determined by the first location information and enters a second cell.

In one embodiment, the meaning of the phrase of at a time determined by the first time information comprises: a current time is a time determined by the first time information.

In one embodiment, the meaning of the phrase of at a time determined by the first time information comprises: within a time determined by the first information.

In one embodiment, in the first time window, the first node does not trigger radio link failure.

In one embodiment, within the first time window, the first node does not trigger or determine handover failure.

In one embodiment, advantages of the above approach are that it avoids pointless failure, which would not result in any improvement in RRC connection re-establishment.

In one embodiment, the first condition set does not comprise a location determined by the first location information.

In one embodiment, the first condition set does not comprise a location determined by the first time information.

In one embodiment, the first condition set comprises being in a specific region and/or at a specific time.

In one subembodiment of the embodiment, the specific region is greater than or comprises a location or region determined by the first location information.

In one subembodiment of the embodiment, the specific region is the black shaded region in FIG. 6.

In one subembodiment of the embodiment, the specific time is longer than or comprises a time determined by the first time information.

In one subembodiment of the embodiment, the method proposed in the present embodiment enables the network to determine, at a coarser granularity, an approximate region within which the first RRC information element is allowed to be executed; the first node determines a best location/region to execute the first RRC information element from a coarser specific region according to, for example, a second condition set that comprises a location or region determined by the first location information.

In one embodiment, conditions comprised in the first condition set are: quality of the target cell is better than or not worse than the first cell, or quality of the target cell is not worse than a difference value of quality of the first cell and M dB, M being a negative number indicated by the first signaling.

In one subembodiment of the above embodiment, conditions comprised in the second condition set are or comprise being at a first moment within the first time window, and the first moment is determined by the first generator.

In one subsidiary subembodiment of the above subembodiment, at the first moment, quality of the second cell can be worse than quality of the first cell.

In one subembodiment of the above embodiment, conditions comprised in the second condition set are or comprise being in a location determined by the first location information, and the first location information is generated by the first generator.

In one subsidiary subembodiment of the above subembodiment, at a location determined by the first location information, quality of the second cell can be worse than quality of the first cell.

In one subembodiment of the above embodiment, conditions comprised in the second condition set comprise, quality of the second cell is better than quality of the first cell Y dB and persists for a first time length, or quality of the first cell is worse than or expected to be worse than Z dB, or quality of the first cell decreases or is expected to decline by more than X dB during a second time length, or N beam failure indications from the physical layer for beams in the first cell are received.

In one subsidiary subembodiment of the above subembodiment, Y, Z, X, the first time length, and the second time length are all determined by the first node.

In one subsidiary subembodiment of the above subembodiment, N is determined by the first node.

In one subembodiment of the above embodiment, conditions comprised in the second condition set are or comprise being at a moment with a highest handover success rate, being at a moment with a lowest interruption probability, and ensuring the highest throughput rate.

In one embodiment, advantages of the above methods are that it can effectively improve the handover performance, reduce the interruption probability and improve the throughput rate.

### Embodiment 7

Embodiment 7 illustrates a schematic diagram of an artificial intelligence processing system according to one aspect of the present application, as shown in FIG. 7. FIG. 7 comprises a first processor, a second processor, a third processor, and a fourth processor.

In Embodiment 7, the first processor transmits a first data set to the second processor, and the second processor generates a target first-type parameter group according to the first data set, the second processor transmits the generated target first-type parameter group to the third processor, and the third processor processes the second data set using the target first-type parameter group to obtain a first-type output, and then transmits the first-type output to the fourth processor.

In one embodiment, the third processor transmits a first-type feedback to the second processor, and the first-type feedback is used to trigger a recalculation or update of the target first-type parameter group.

In one embodiment, the fourth processor transmits a second-type feedback to the first processor, the second-type feedback is used to generate the first data set or the second data set, or the second-type feedback is used to trigger a transmission of the first data set or second data set.

In one embodiment, the first processor generates the first data set and the second data set according to at least a measurement of a radio signal in a measurement of a radio signal, input of network, time, location, and quality requirements of services, and the first radio signal comprises a first reference signal.

In one subembodiment of the embodiment, a transmitter of the first reference signal is the target cell.

In one subembodiment of the embodiment, an input of the network comprises at least partial parameters comprised in the first signaling.

In one subembodiment of the embodiment, an input of the network comprises at least partial parameters comprised in the second signaling.

In one subembodiment of the embodiment, an input of the network comprises the first parameter set.

In one embodiment, the first processor and the third processor belong to a first node.

In one subembodiment of the embodiment, the fourth processor belongs to a second node, and the first-type output comprises second information.

In one subembodiment of the above embodiment, the first node generates the first location information.

In one subembodiment of the above embodiment, the first node generates the first time information.

In one embodiment, the first-type output comprises second information.

In one embodiment, the second processor belongs to a first node.

The above embodiment avoids passing the first data set to a second node.

In one embodiment, the second processor belongs to a second node.

The above embodiments reduce the complexity of the first node.

In one embodiment, the fourth processor is optional.

In one embodiment, the fourth processor belongs to the first node.

In one subembodiment of the embodiment, the fourth processor is optional.

In one subembodiment of the embodiment, the fourth processor is used to check the accuracy of the first-type output.

In one embodiment, the first processor and the third processor belong to a second node.

In one subembodiment of the embodiment, the fourth processor belongs to a first node, and the first-type output comprises second information.

In one subembodiment of the embodiment, the fourth processor is optional.

In one subembodiment of the embodiment, the fourth processor is used to check the accuracy of the first-type output.

In one subembodiment of the embodiment, the first signaling indicates the second information.

In one embodiment, the second node is a transmitter of the first signaling.

In one embodiment, the second node is a serving cell of the first node.

In one embodiment, the first data set is training data, the second data set is Inference Data, the second processor is used to train the model, and the trained model is described by the target first-type parameter group.

In one embodiment, the third processor constructs a model according to the target first-type parameter set, and then inputs the second data set into the constructed model to obtain the first-type output, which is then transmitted to the fourth processor.

In one subembodiment of the above embodiment, the third processor comprises a first encoder of the present application, the first encoder is described by the target first-type parameter group, and a generation of the first-type output is executed by the first encoder.

In one embodiment, the third processor calculates an error between the first-type output and the actual data to determine the performance of the trained model; the actual data is data received after the second data set and transmitted by the first processor.

The above embodiment is particularly suitable for prediction-related reporting, such as predicting that the first node is about to enter a location determined by the first location information, and how long the first node will remain in a location determined by the first location information, whether it will exceed a time determined by the first time information.

In one embodiment, the third processor recovers a reference data set according to the first-type output, and the error between the reference data set and the second data set is used to generate the first-type feedback.

In one embodiment, the first-type feedback is used to reflect the performance of the trained model; when the performance of the trained model cannot meet the requirements, the second processing occasion recalculates the target first-type parameter group.

In one subembodiment of the above embodiment, the third processor comprises a first reference decoder of the present application, and the first reference decoder is described by the target first class parameter group; an input of the first reference decoder comprises the first-type output, and an output of the first reference decoder comprises the reference data set.

Typically, the performance of the trained model is considered unsatisfactory when an error is too large or has not been updated for too long.

In one embodiment of the above embodiment, when the model is used to determine whether the first condition is met, it can be considered that the first condition is not met.

In one embodiment, the third processor belongs to the second node, and the first node reports the target first-type parameter group to the second node.

In one embodiment, when the third processor is used to generate first location information and/or the first time information, an input of the third processor may comprise previously generated first location information and/or first time information.

In one subembodiment of the embodiment, the third processor can iteratively optimize information to be generated.

In one embodiment, the third processor is the first-type generator.

### Embodiment 8

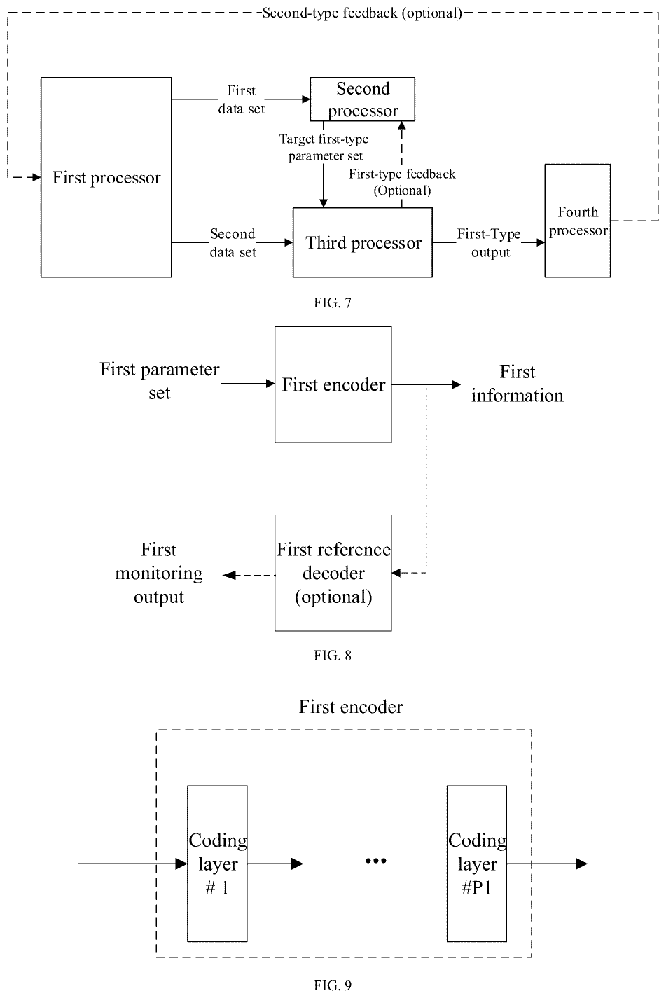

Embodiment 8 illustrates a flowchart of a generation of second information according to one embodiment of the present application, as shown in FIG. 8. In FIG. 8, a first reference decoder is optional.

In one embodiment, in embodiment 8, a first encoder belongs to the first node; herein, the first encoder belongs to a first receiver.

Advantage of the above embodiments is that the capability or information of the first node can be more utilized, especially the information that cannot be shared with the network side, and more accurate results can be obtained; the first node does not need to hand over a large number of parameters or information to the network, saving communication resources and protecting privacy.

In one embodiment, in embodiment 8, a first encoder belongs to the second node; herein, the first encoder belongs to a second receiver.

Advantages of the above embodiment are that the complexity of the first node is reduced and more power is saved, and the network can train and optimize the first encoder using information submitted by multiple users.

In one embodiment, the first receiver generates the second information using a first encoder; herein, an input of the first encoder comprises the first parameter set, and the first encoder is obtained through training.

In one subembodiment of the embodiment, the first parameter set comprises a measurement result based on a reference signal or reference signal resources.

In one subembodiment of the embodiment, the network configures the reference signal or reference signal resources.

In one subembodiment of the embodiment, how to configure the reference signal or reference signal resources through signaling in the network is the prior art in this field.

In one embodiment, the first parameter set comprises a channel parameter matrix, or a matrix composed of at least one eigenvector.

In one embodiment, the first parameter set comprises a first channel matrix.

In one embodiment, the first channel matrix is a precoding matrix used for calculating CQI (channel quality indication) based on the channel information.

In one embodiment, the first receiver further comprises a first reference decoder, an input of the first reference decoder comprises the second information, and an output of the first reference decoder comprises a first monitoring output.

In one embodiment, the first channel matrix is the first monitoring output.

In one embodiment, the first receiver comprises the third processor in embodiment 7.

In one embodiment, the first parameter set belongs to a second data set in embodiment 7.

In one embodiment, the training of the first encoder is executed at the first node.

In one embodiment, the training of the first encoder is executed by the second node.

In one embodiment, a first-type index is associated with a first encoder.

In one embodiment, a first-type index is an index or identity of a first encoder.

In one embodiment, the first encoder is indexed by the first-type index.

In one embodiment, the first encoder can be indexed by the first-type index.

In one embodiment, the first channel information comprises CSI (channel state information).

In one embodiment, the first channel input comprises a measurement result for downlink reference signal resources.

In one embodiment, the first-type index is associated with a first reference decoder.

In one embodiment, the first-type index is an index or identity of a first reference decoder.

In one embodiment, the first location information depends on the first parameter set.

In one embodiment, the first time information depends on the first parameter set.

In one embodiment, the first reference decoder is indexed by the first-type index.

In one embodiment, the first reference decoder can be indexed by the first-type index.

In one embodiment, the first parameter set comprises a target parameter group.

In one embodiment, the first parameter set comprises geographic location information of the first node.

In one embodiment, the first parameter set comprises geographic location information of the transmitting point.

In one embodiment, the first parameter set comprises map information.

In one embodiment, the first parameter set comprises historical information of the first location information and/or first time information.

In one embodiment, the first parameter set comprises motion speed of the first node.

In one embodiment, the first parameter set comprises an estimate of the motion trajectory of the first node.

In one embodiment, the first parameter set comprises the traffic volume of the first node.

In one embodiment, the first parameter set comprises a delay requirement of services of the first node.

In one embodiment, the first parameter set comprises an estimate of the first location information from other terminals.

In one embodiment, the first encoder is the first-type generator.

### Embodiment 9

Embodiment 9 illustrates a schematic diagram of a first encoder according to one embodiment of the present application, as shown in FIG. 9. In FIG. 9, the first encoder comprises P1 encoding layers, namely encoding layers #1, #2, . . . , #P1.

In one embodiment, P1 is 2, that is, the P1 encoding layers comprise encoding layer #1 and encoding layer #2, and the encoding layer #1 and encoding layer #2 are convolutional layer and fully connected layer respectively; in the convolutional layer, at least one convolutional kernel is used to convolve the first parameter set to generate a corresponding feature map, and at least one feature map output by the convolution layer is reshaped into a vector and input to the fully connected layer; the fully connected layer converts the one vector into the second information. For a more detailed description, refer to CNN-related technical literature, e.g., Chao-Kai Wen, Deep Learning for Massive MIMO CSI Feedback, IEEE WIRELESS COMMUNICATIONS LETTERS, VOL. 7, NO. 5, OCTOBER 2018 and etc.

In one embodiment, P1 is 3, that is, the P1 coding layers comprise a fully connected layer, a convolutional layer and a pooling layer.

In one embodiment, the first parameter set comprises at least one parameter indicated by the first signaling.

In one embodiment, the second information is generated by the first node.

In one embodiment, the first parameter set comprises at least one parameter reported by the first node.

In one embodiment, the second information comprises the first location information.

In one embodiment, the second information comprises the first time information.

### Embodiment 10

Embodiment 10 illustrates a schematic diagram of a first function according to one embodiment of the present application, as shown in FIG. 10. In FIG. 10, the first function comprises a pre-processing layer and P2 decoding layer groups, namely decoding layer groups #1, #2, . . . , #P2, and each decoding layer group comprises at least one decoding layer.

The structure of the first function is applicable to a first reference decoder in embodiment 8.

In one embodiment, the pre-processing layer is a fully connected layer that enlarges a size of the second information to a size of the first parameter set.

In one embodiment, any two of the P2 decoding layer groups have a same structure, the structure comprises a number of comprised decoding layers, a size of input parameters and a size of output parameters of each comprised decoding layer and etc.

In one embodiment, the second node indicates the structure of the P2 and the decoding layer group to the first node, and the first node indicates other parameters of the first function through the second signaling.

In one embodiment, the other parameters comprise at least one of a threshold of an activation function, a size of the convolution kernel, a step size of the convolution kernel, and the weight between feature maps.

In one embodiment, the first-type index is an input of the first function.

In one embodiment, the first-type index is an output of the first function.

In one embodiment, the first-type index is associated with the first function.

In one embodiment, the first-type index is an index of the first function.

In one embodiment, the first function is indexed by the first-type index.

In one embodiment, the first function can be indexed by the first-type index.

In one embodiment, the first location information may explicitly comprise information about the region.

In one embodiment, the first location information needs to be processed to obtain specific information about region.

In one subembodiment of the above embodiment, the first location information comprises a sequence.

In one subembodiment of the above embodiment, the first location information comprises an index.

In one subembodiment of the above embodiment, the first location information is information of a compressed region.

In one subembodiment of the above embodiment, the phrase of being processed comprises performing decoding by using the first function.

In one embodiment, for any decoding layer group #j, including L layers, i.e. layers #1, #2, . . . , #L; the decoding layer group is any of the P2 decoding layer groups.

In one embodiment, L is 4, the first one of the L layers is an input layer, and the last three layers of the L layers are all convolutional layers, and for a more detailed description, refer to CNN-related technical literature, e.g., Chao-Kai Wen, Deep Learning for Massive MIMO CSI Feedback, IEEE WIRELESS COMMUNICATIONS LETTERS, VOL. 7, NO. 5, OCTOBER 2018 and etc.

In one embodiment, the L layers comprise at least one convolutional layer and one pooling layer.

### Embodiment 11

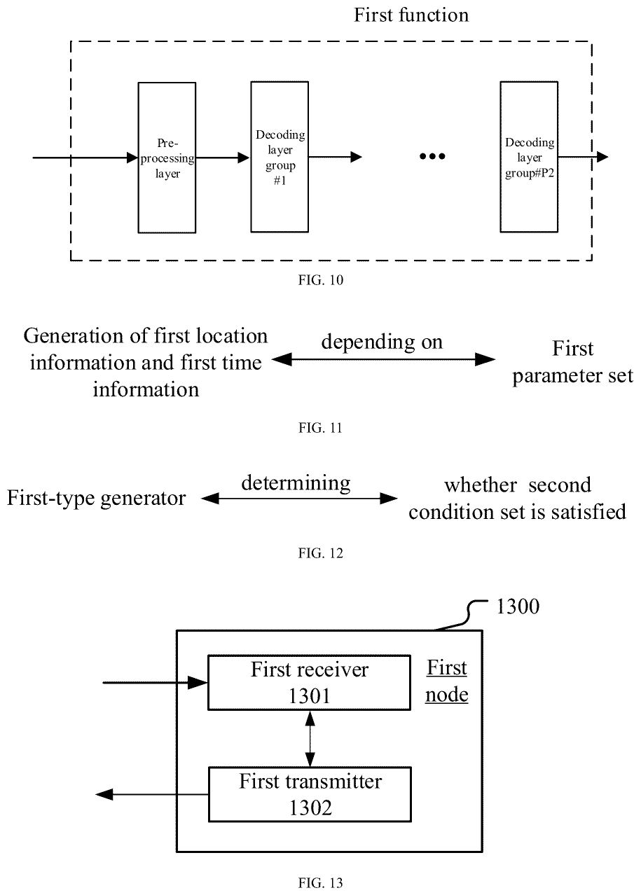

Embodiment 11 illustrates a schematic diagram of a generation of first location information and first time information depending on a first parameter set according to one embodiment of the present application, as shown in FIG. 11.

In one embodiment, the network indicates the first parameter set.

In one embodiment, the first parameter set is an input parameter of the first-type generator, and the first generator outputs the first location information and the first time information.

In one embodiment, the first parameter set provides generation parameters for generating the first time information from the first location information.

In one subembodiment of the embodiment, the second condition set depends on a latter of the first location information and the first time information.

In one subembodiment of the embodiment, the first parameter set comprises a mapping relation.

In one subembodiment of the embodiment, the first parameter set comprises parameters of a generation function that generates the first time information from the first location information.

In one subembodiment of the embodiment, the first parameter set comprises predictions of the motion trajectory, and the first time information comprises a time at which the prediction of the motion trajectory arrives at a location determined by the first location information.

In one subembodiment of the embodiment, the network uses artificial intelligence and/or past information and/or the current motion speed and/or geographical environment to predict the motion trajectory of the first node.

In one subembodiment of the embodiment, the first parameter set comprises predictions of transmit power of network nodes.

In one subembodiment of the embodiment, the first parameter set comprises predictions of interference.

In one embodiment, the first node generates the first location information and the first time information using the processing method in Embodiment 7.

In one subembodiment of the embodiment, the first data set comprises the first parameter set.

In one subembodiment of the embodiment, the first data set is used for training.

In one subembodiment of the embodiment, the second data set comprises the first parameter set.

In one subembodiment of the embodiment, the second data set is used to generate the first location information and the first time information.

In one embodiment, the first signaling indicates the first parameter set.

In one embodiment, the first parameter set comprises a third threshold.

In one embodiment, when a third threshold is a maximum delay allowed by the services of the first node.

In one embodiment, when a third threshold is a maximum delay for retaining an RRC connection of the first node.

In one embodiment, when a third threshold is a DRX (discontinuous reception) cycle of the first node.

In one embodiment, when a third threshold is Q times a DRX cycle of the first node.

In one subembodiment of the above embodiment, Q is a positive integer not greater than 1024.

In one embodiment, advantage of the above method is that the quality of the service can be better guaranteed.

In one embodiment, a time determined by the first time information is not longer than the third threshold.

In one embodiment, a location determined by the first location information is not greater than a distance determined by the third threshold and the estimated motion speed of the first node.

In one embodiment, a location determined by the first location information is not greater than a region determined by the third threshold and the estimated motion of the first node.

In one embodiment, a location determined by the first location information is a region not greater than a region determined by the third threshold and the estimated motion of the first node within a region with the worst radio link quality.

In one embodiment, the first parameter set comprises a first region, and the first location information comprises the first region.

In one subembodiment of the above embodiment, the first node generates the first location information.

In one embodiment, the first parameter set comprises a second region, and the first location information does not comprise the second region.

In one subembodiment of the above embodiment, the first node generates the first location information.

In one embodiment, advantages of the above two embodiments comprise: the first node can be assisted in generating the first location information more accurately.

In one embodiment, the first parameter set comprises a generation model that indexes at least one of first location information or first time information, and/or an encoder and/or an index of the first function.

In one embodiment, the first parameter set comprises a first time interval, and the first time information comprises the first time interval.

In one subembodiment of the above embodiment, the first node generates the first time information.

In one embodiment, the first parameter set comprises a second time interval, and the first time information does not comprise the second time interval.

In one subembodiment of the above embodiment, the first node generates the first time information.

In one embodiment, advantages of the above two embodiments comprise: the first node can be assisted in generating the first time information more accurately.

In one embodiment, the first parameter set indicates a number of iterations used in the model for generating the first location information and/or the first time information.

In one embodiment, the first parameter set indicates a configuration of an encoder that generates the first location information and/or the first time information, such as a number of layers.

In one embodiment, the first parameter set comprises coverage information, such as the covered heat map.

In one embodiment, the first parameter set comprises measurement results of other nodes.

In one embodiment, the first parameter set comprises interference information, such as interference maps.

In one embodiment, the first parameter set comprises an intermediate result, such as an intermediate result of the first encoder.

In one subembodiment of the embodiment, the first node and the network jointly train and/or generate the first location information and/or the first time information.

In one embodiment, advantages of the above embodiments comprise: being able to generate the first location information and the first time information more accurately.

In one embodiment, the first parameter set indicates at least one reference signal resource.

In one embodiment, the first node generating the first location information and/or the first time information must use a measurement result on at least one reference signal resource indicated by the first parameter set.

In one embodiment, the first parameter set indicates a generation accuracy or confidence level of at least one of the first location information or the first time information.

In one embodiment, the second signaling comprises a first parameter set, and the generation of the first location information and the first time information depends on the first parameter set.

In one subembodiment of the embodiment, the meaning of the phrase that a generation of the first location information and the first time information depends on the first parameter set comprises: the first parameter set indicates a prediction model that generates at least one of the first location information or the first time information.

In one subembodiment of the embodiment, the meaning of the phrase that a generation of the first location information and the first time information depends on the first parameter set comprises: the first parameter set indicates the complexity of a prediction model that generates at least one of the first location information or the first time information.

In one subembodiment of the embodiment, the meaning of the phrase that a generation of the first location information and the first time information depends on the first parameter set comprises: the first parameter set indicates a dimensionality of a prediction model that generates at least one of the first location information or the first time information.

In one subembodiment of the embodiment, the meaning of the phrase that a generation of the first location information and the first time information depends on the first parameter set comprises: the first parameter set indicates a number of layer(s) of a prediction model that generates at least one of the first location information or the first time information.

In one subembodiment of the embodiment, the meaning of the phrase that a generation of the first location information and the first time information depends on the first parameter set comprises: the first parameter set indicates a convergence requirement of a prediction model that generates at least one of the first location information or the first time information.

In one subembodiment of the embodiment, the meaning of the phrase that a generation of the first location information and the first time information depends on the first parameter set comprises: the first parameter set indicates an error or accuracy requirement of a prediction model that generates at least one of the first location information or the first time information.

In one subembodiment of the embodiment, the meaning of the phrase that a generation of the first location information and the first time information depends on the first parameter set comprises: training of a prediction model that generates at least one of the first location information or the first time information depends on the first parameter set.

In one subembodiment of the embodiment, the meaning of the phrase that training of a prediction model that generates at least one of the first location information or the first time information depends on the first parameter set comprises: the first parameter controls the training of a prediction model that generates at least one of the first location information or the first time information.

In one subembodiment of the embodiment, the meaning of the phrase that training of a prediction model that generates at least one of the first location information or the first time information depends on the first parameter set comprises: the first parameter serves as an input for the training of a prediction model that generates at least one of the first location information or the first time information.

In one subembodiment of the embodiment, the meaning of the phrase that training of a prediction model that generates at least one of the first location information or the first time information depends on the first parameter set comprises: the first parameter assists in the training of a prediction model that generates at least one of the first location information or the first time information.

In one subembodiment of the embodiment, the meaning of the phrase that training of a prediction model that generates at least one of the first location information or the first time information depends on the first parameter set comprises: the first parameter validates the training of a prediction model that generates at least one of the first location information or the first time information.

### Embodiment 12

Embodiment 12 illustrates a schematic diagram of a first-type generator determining whether a second condition set is met according to an embodiment of the present application, as shown in FIG. 12.

In one embodiment, the first-type generator corresponds to a third processor in embodiment 7.

In one embodiment, the first-type generator outputs a predicted handover success rate for executing the first RRC information element at different time points.

In one subembodiment of the above embodiment, the first node executes the first RRC information element at the point in time where the predicted handover success rate is highest.

In one subembodiment of the above embodiment, the second condition set comprises: at the time point with the highest handover success rate.

In one subembodiment of the above embodiment, the different time points are not later than a time point of an end of the first time window.

In one subembodiment of the above embodiment, the first node needs to be greater than a first specific threshold at a time point when handover success rate of the first prediction is highest.

In one subembodiment of the above embodiment, the first specific threshold is indicated by the first signaling.

In one subembodiment of the above embodiment, the first specific threshold is determined by the first node itself.

In one embodiment, the first-type generator outputs a predicted interruption probability for executing the first RRC information element at different time points.

In one subembodiment of the above embodiment, the second condition set comprises: at the time point with the lowest interruption probability.

In one subembodiment of the above embodiment, the first node executes the first RRC information element at a time point when the predicted interruption probability is lowest.

In one subembodiment of the above embodiment, the different time points are not later than a time point of an end of the first time window.

In one subembodiment of the above embodiment, the first node needs to be lower a second specific threshold at a time point when the interruption probability of the first prediction is the lowest.

In one subembodiment of the above embodiment, the second specific threshold is indicated by the first signaling.

In one subembodiment of the above embodiment, the second specific threshold is determined by the first node itself.

In one embodiment, the first-type generator outputs a predicted probability of radio link failure for executing the first RRC information element at different time points.

In one subembodiment of the above embodiment, the first node executes the first RRC information element at a time point where the predicted probability of radio link failure is the lowest.

In one subembodiment of the above embodiment, the different time points are not later than a time point of an end of the first time window.

In one subembodiment of the above embodiment, the first node needs to be lower a third specific threshold at a time point when probability of radio link failure of the first prediction is the lowest.

In one subembodiment of the above embodiment, the third specific threshold is indicated by the first signaling.

In one subembodiment of the above embodiment, the third specific threshold is determined by the first node itself.

In one embodiment, the first-type generator outputs predicted quality of experience for executing the first RRC information element at different time points.

In one subembodiment of the above embodiment, the first node executes the first RRC information element at the predicted optimal time point for quality of experience.

In one subembodiment of the above embodiment, the different time points are not later than a time point of an end of the first time window.

In one subembodiment of the above embodiment, the first node needs to be greater than a fourth specific threshold at a best time point for quality of experience of the first prediction.

In one subembodiment of the above embodiment, the fourth specific threshold is indicated by the first signaling.

In one subembodiment of the above embodiment, the fourth specific threshold is determined by the first node itself.

In one subembodiment of the above embodiment, the user experience comprises: 95% of data packets have a delay lower than a delay required by QoS.

In one subembodiment of the above embodiment, the quality of experience comprises: do not lose any I frame.

In one subembodiment of the above embodiment, the quality of experience comprises: cache not overflowing.

In one subembodiment of the above embodiment, the quality of experience comprises: BLER (block error rate) shall not exceed x %.

In one subsidiary embodiment of the above subembodiment, x is determined by the first node itself.

In one subsidiary embodiment of the above subembodiment, x is indicated by the first signaling.

In one subembodiment of the above embodiment, the quality of experience comprises: FER (frame error rate) shall not exceed y %.

In one subsidiary embodiment of the above subembodiment, y is determined by the first node itself.

In one subsidiary embodiment of the above subembodiment, y is indicated by the first signaling.

In one subembodiment of the above embodiment, the quality of experience comprises: dropout rate of PDU sets shall not exceed z % and/or an average delay or a maximum latency of PDU sets shall not exceed t milliseconds.

In one subsidiary embodiment of the above subembodiment, t is determined by the first node itself.

In one subsidiary embodiment of the above subembodiment, t is indicated by the first signaling.

In one subsidiary embodiment of the above subembodiment, z is determined by the first node itself.

In one subsidiary embodiment of the above subembodiment, z is indicated by the first signaling.

In one subsidiary embodiment of the above subembodiment, the PDU set is used for transmitting XR (Extended Reality) services.

In one subsidiary embodiment of the above subembodiment, a PDU set consists of one or more payload PDUs carrying a unit of information generated by the application layer.

In one embodiment, the second condition set comprises: being at a location determined by the first location information.

In one embodiment, the second condition set comprises: being at a time determined by the first time information.

In one embodiment, a location determined by the first location information may be a sub-region.

In one embodiment, the first location information comprises Z-axis information, i.e. height information.

In one embodiment, the first location information depends on the first time information.

In one subembodiment of the embodiment, correspond to different sub-information in the first location information at different times indicated by the first time information.

In one subembodiment of the embodiment, the first location information may be different at different times indicated by the first time information.

In one subembodiment of the embodiment, a location or region determined by the first location information depends on being at or expected to be at a time determined by the first time information.

In one subembodiment of the embodiment, the first node first determines whether it is at or expected to be at a time determined by the first time information, and then determines the first location information according to the time determined by the first time information, for example, through a mapping relation.

In one embodiment, an input of the first-type generator comprises the first location information and/or the first time information.

In one embodiment, the first node is currently located at a location determined by the first location information, and the second condition set is met.

In one embodiment, the first node is currently within a time determined by the first time information, and the second condition set is met.

In one embodiment, the first node is currently within a location determined by the first location information and within a time determined by the first time information, and the second condition set is met.

In one embodiment, the first node is expected to be located at a location determined by the first location information, and the second condition set is met.

In one embodiment, advantages of the above methods comprise the ability to make full use of artificial intelligence techniques to accurately, especially result-oriented or quality-oriented, determine the best moment to execute the first RRC information element.

### Embodiment 13

Embodiment 13 illustrates a structure block diagram of a processor in a first node according to one embodiment of the present application, as shown in FIG. 13. In FIG. 13, a processor 1300 in a first node comprises a first receiver 1301, a first transmitter 1302. In embodiment 13,

a first receiver 1301 receives a first signaling, the first signaling comprises a first RRC information element, the first signaling configures a first condition set and a first time window; there exists a dependency relation between the first condition set and the first time window; an execution of the first RRC information element depends on the first condition set;

herein, the first RRC information element configures a target cell of the first node; the meaning of the phrase that an execution of the first RRC information element depends on the first condition set is: when at least one condition in the first condition set is not met, the first RRC information element is not executed; when all conditions in the first condition set are met, the first RRC information element is delayed in execution; the delayed in execution is not later than an end of the first time window.

In one embodiment, the meaning of the phrase that there exists a dependency relation between the first condition set and the first time window is: the first condition set depending on the first time window.

In one embodiment, the meaning of the phrase that there exists a dependency relation between the first condition set and the first time window is: the first time window depends on the first condition set.

In one embodiment, the first signaling comprises first indication information, the first indication information indicates that when all conditions in the first condition set are met, the first RRC information element is allowed to be delayed in execution.

In one embodiment, the meaning of delayed in execution comprises: when all conditions in the first condition set are met, and only when the second condition set is met, the first RRC information element is executed; the second condition set is not explicitly indicated.

In one embodiment, the second condition set comprises at least one prediction-based condition.

In one embodiment, the prediction comprises a prediction of at least one channel quality, handover failure probability, handover success probability, interruption probability, throughput rate, or quality of user experience.

In one embodiment, the second condition set comprises at least one of being at a location determined by the first location information and being within a time determined by first time information.

In one embodiment, the first transmitter 1302 transmits first information; the first information indicates a second capability;

herein, the second capability supports a first-type generator; the first-type generator depends on training; the first-type generator determines whether the second condition set is met.

In one embodiment, the first transmitter 1302 transmits first information; the first information indicates a first capability;

herein, the first capability supports a delayed execution for the first RRC information element; the first signaling depends on the first capability.

In one embodiment, the first receiver 1301 receives a second signaling, the second signaling comprises a first parameter set, and a generation of the first location information and the first time information depends on the first parameter set; herein, the meaning of the phrase that a generation of the first location information and the first time information depends on the first parameter set comprises: the first parameter set indicates a prediction model that generates at least one of the first location information or the first time information, or the training of the prediction model that generates at least one of the first location information or the first time information depends on the first parameter set.

In one embodiment, the first signaling comprises multiple RRC information elements, the first RRC information element is one of the multiple RRC information elements, and each of the multiple RRC information elements is associated with a condition set, and when a condition set associated with any of the multiple RRC information elements is not met, the any RRC information element in the multiple RRC information elements is not executed; when a condition set associated with any of the multiple RRC information elements is met, an execution of the any RRC information element in the multiple RRC information elements is delayed.

In one embodiment, the first node is a UE and a mobile.

In one embodiment, the first node is an intelligent terminal or sensor.

In one embodiment, the first node is a terminal that supports large delay differences.

In one embodiment, the first node is an aircraft, vessel, or vehicle terminal.

In one embodiment, the first node is an Internet of Things (IoT) terminal or an Industrial Internet of Things (IIoT) terminal.

In one embodiment, the first node is a device that supports transmission with low-latency and high-reliability.

In one embodiment, the first receiver 1301 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 1302 comprises at least one of the antenna 452, the transmitter 454, the transmitting processor 468, the multi-antenna transmitting processor 457, the controller/processor 459, the memory 460 or the data source 467 in Embodiment 4.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The user equipment, terminal and UE include but are not limited to Unmanned Aerial Vehicles (UAVs), communication modules on UAVs, telecontrolled aircrafts, aircrafts, diminutive airplanes, mobile phones, tablet computers, notebooks, vehicle-mounted communication equipment, wireless sensors, network cards, Internet of Things (IoT) terminals, RFID terminals, NB-IoT terminals, Machine Type Communication (MTC) terminals, enhanced MTC (eMTC) terminals, data card, network cards, vehicle-mounted communication equipment, low-cost mobile phones, low-cost tablets, vessel communications equipment and other wireless communication devices. The base station or system equipment in the present application includes but is not limited to macro cellular base stations, micro cellular base stations, home base stations, relay base stations, gNB (NR Node B) NR Node B, TRP (Transmitter Receiver Point), NTN base stations, flight platform equipment and other wireless communication devices.

This application can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first signaling, the first signaling comprising a first RRC information element, the first signaling configuring a first condition set and a first time window; there existing a dependency relation between the first condition set and the first time window; an execution of the first RRC information element depending on the first condition set;
wherein the first RRC information element configures a target cell of the first node; the meaning of an execution of the first RRC information element depending on the first condition set is: when at least one condition in the first condition set is not met, the first RRC information element is not executed; when all conditions in the first condition set are met, the first RRC information element is delayed in execution; the delayed in execution is not later than an end of the first time window.

2. The first node according to claim 1, wherein
the meaning of there existing a dependency relation between the first condition set and the first time window is: the first condition set depending on the first time window.

3. The first node according to claim 1, wherein
the meaning of there existing a dependency relation between the first condition set and the first time window is: the first time window depending on the first condition set.

4. The first node according to claim 1, wherein
the first signaling comprises first indication information, the first indication information indicates that when all conditions in the first condition set are met, the first RRC information element is allowed to be delayed in execution.

5. The first node according to claim 1, wherein
the meaning of delayed in execution comprises: when all conditions in the first condition set are met, and only when the second condition set is met, the first RRC information element is executed; the second condition set is not explicitly indicated.

6. The first node according to claim 2, wherein
the meaning of delayed in execution comprises: when all conditions in the first condition set are met, and only when the second condition set is met, the first RRC information element is executed; the second condition set is not explicitly indicated.

7. The first node according to claim 3, wherein
the meaning of delayed in execution comprises: when all conditions in the first condition set are met, and only when the second condition set is met, the first RRC information element is executed; the second condition set is not explicitly indicated.

8. The first node according to claim 4, wherein
the second condition set comprises at least one prediction-based condition.

9. The first node according to claim 6, wherein
the second condition set comprises at least one prediction-based condition.

10. The first node according to claim 7, wherein
the second condition set comprises at least one prediction-based condition.

11. The first node according to claim 8, wherein
the prediction comprises a prediction of at least one channel quality, handover failure probability, handover success probability, interruption probability, throughput rate, or quality of user experience.

12. The first node according to claim 9, wherein
the prediction comprises a prediction of at least one channel quality, handover failure probability, handover success probability, interruption probability, throughput rate, or quality of user experience.

13. The first node according to claim 10, wherein
the prediction comprises a prediction of at least one channel quality, handover failure probability, handover success probability, interruption probability, throughput rate, or quality of user experience.

14. The first node according to claim 5, wherein
the second condition set comprises at least one of being at a location determined by the first location information and being within a time determined by first time information.

15. The first node according to claim 5, comprising:
a first transmitter, transmitting first information; the first information indicating a second capability;
wherein the second capability supports a first-type generator; the first-type generator depends on training; the first-type generator determines whether the second condition set is met.

16. The first node according to claim 6, comprising:
a first transmitter, transmitting first information; the first information indicating a second capability;
wherein the second capability supports a first-type generator; the first-type generator depends on training; the first-type generator determines whether the second condition set is met.

17. The first node according to claim 7, comprising:
a first transmitter, transmitting first information; the first information indicating a second capability;
wherein the second capability supports a first-type generator; the first-type generator depends on training; the first-type generator determines whether the second condition set is met.

18. A method in a first node for wireless communications, comprising:
receiving a first signaling, the first signaling comprising a first RRC information element, the first signaling configuring a first condition set and a first time window; there existing a dependency relation between the first condition set and the first time window; an execution of the first RRC information element depending on the first condition set;
wherein the first RRC information element configures a target cell of the first node; the meaning of an execution of the first RRC information element depending on the first condition set is: when at least one condition in the first condition set is not met, the first RRC information element is not executed; when all conditions in the first condition set are met, the first RRC information element is delayed in execution; the delayed in execution is not later than an end of the first time window.

19. The method in a first node according to claim 18, wherein
the meaning of delayed in execution comprises: when all conditions in the first condition set are met, and only when the second condition set is met, the first RRC information element is executed; the second condition set is not explicitly indicated.

20. The method in a first node according to claim 19, comprising:
transmitting first information; the first information indicating a second capability;
wherein the second capability supports a first-type generator; the first-type generator depends on training; the first-type generator determines whether the second condition set is met.
